(19) United States
(12) Patent Application Publication
(10) Pub. No.: US 2010/0226459 A1
(43) Pub. Date: Sep. 9, 2010

(54) Apparatus and Method for I/Q Modulation

(76) Inventors: Seung-Keun Park, Daejeon-city (KR); Jin-A Park, Daejeon-city (KR); Pyung-Dong Cho, Daejeon-city (KR); Sanghoon Kim, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/223,854

(22) PCT Filed: Dec. 7, 2006
(86) PCT No.: PCT/KR2006/005297

§ 371 Date: May 21, 2010

(30) Foreign Application Priority Data
Feb. 8, 2006 (KR) 10-2006-0011911
May 1, 2006 (KR) 10-20060039285
Dec. 6, 2006 (KR) 10-2006-0123400

(51) Int. Cl. H04L 27/12; H04L 27/36

(52) U.S. Cl. 375/298; 375/302

(57) ABSTRACT

An apparatus and method for I/Q modulation are provided. According to the apparatus and method, the symbol error probability performance of a conventional I/Q modulation method can be improved by a maximum of 3dB, and when the same symbol error rate (SER) as that of the conventional method is obtained, the power consumption can be reduced to half that required by the conventional method. The apparatus includes: an oscillator generating a sine wave signal; an IQ sine wave signal generation unit adjusting the phase of the sine wave signal based on I channel data and Q channel data, thereby generating an I channel sine wave signal and a Q channel sine wave signal such that a signal obtained by mixing a first signal and a second signal satisfies the condition that the mixed signal has a phase on a signal constellation diagram corresponding to the I and Q channel data, in which the first signal is obtained by applying the I channel data to the I channel sine wave signal and the second signal obtained by applying the Q channel data to the Q channel sine wave signal; and a transmission signal generation unit generating a transmission signal corresponding to the I and Q channel data, by respectively applying the I channel data and the Q channel data to the I channel sine wave signal and the Q channel sine wave signal.

### CROSS-REFERENCE TO RELATED PATENT APPLICATION

This application claims the benefits of Korean Patent Application Nos. 10-2006-0011911, 10-2006-0039285, and 10-2006-0123400, respectively filed on Feb. 8, 2006, May 1, 2006, and Dec. 6, 2006, in the Korean Intellectual Property Office, the disclosure of which is incorporated herein in its entirety by reference.

### BACKGROUND OF THE INVENTION

1. Field of the Invention

The present invention relates to a modulation method for a communication system, and more particularly, to an I/Q modulation apparatus and method.

2. Description of the Related Art

An I/Q modulation apparatus generates a transmission signal composed of an I channel signal and a Q Channel signal. There are many methods for doing so, including quadrature phase shifting keying (QPSK), offset quadrature phase shift keying (OQPSK), n14-differential quadrature phase shifting keying (DQPSK), QPSK, hybrid QPSK, M-ary phase shift keying (MPSK), amplitude phase shift keying (APSK), and hierarchical PSK.

FIG. 1 is a diagram illustrating a conventional I/Q modulation apparatus. Referring to FIG. 1, a binary stream 1 is input to a baseband signal processing unit 2. According to a variety of I/Q modulation signal mapping techniques, such as QPSK and MPSK, the baseband I/Q modulation signal processing unit 2 generates Iₖ, which is I channel data, and Qₖ, which is Q channel data, in each symbol time interval Tₛ. Iₖ and Qₖ together determine a transmission symbol. Iₖ and Qₖ are transmitted through separate data paths, that is, through an I channel data path and a Q channel data path.

A baseband filter 3 of the I channel and a baseband filter 4 of the Q channel respectively filter the input signals Iₖ and Qₖ and generate two signals I(t) and Q(t), as equations 1 and 2 below:

$$\begin{matrix}I ( t ) = {\#}_{k = !}^{!} {I}_{k} p ( t {kT}_{S} ) & ( 1 ) \\ Q ( t ) = {\#}_{k = !}^{!} {Q}_{k} p ( t {kT}_{S} ) & ( 2 )\end{matrix}$$

Here, k is a transmission symbol index, p(t) is a time function, i.e. a pulse, of a baseband filter defined at [0,Tₛ] that is a symbol time interval.

Acosω_{c}t is a sine wave signal generated by an oscillator 5, and branches to the I channel data path and the Q channel data path. In this case, since the power of the output signal Acosω_{c}t of the oscillator 5 branches to the I channel data path and the Q channel data path, the power is divided into halves. As a result, to a mixer of the I channel data path, i.e. an I channel mixer, (A/\sqrt{2})cosω_{c}t is provided, and to a mixer of the Q channel data path, i.e. a Q channel mixer, −(A/\sqrt{2})sin ω_{c}t is provided through a π/2 phase shifter 6. Hereinafter, for convenience, a sine wave signal provided to the I channel mixer is referred to as an I channel sine wave signal and a sine wave signal provided to the Q channel mixer is referred to as a Q channel sine wave signal. The I channel mixer mixes I(t) and the I channel sine wave signal and the Q channel mixer mixes Q(t) and the Q channel sine wave signal. Referring to FIG. 1, the I channel sine wave signal is (A/\sqrt{2})cosω_{c}t and the Q channel sine wave signal is −(A/\sqrt{2})sin ω_{c}t. Hereinafter, for convenience, a signal obtained by applying the I channel data to the I channel sine wave signal is referred to as a first signal, and a signal obtained by applying the Q channel data to the Q channel sine wave signal is referred to as a second signal. Referring to FIG. 1, the first signal is the output of the I channel mixer and the second signal is the output of the Q channel mixer.

A combining unit 7 combines the output of the I channel mixer and the output of the Q channel mixer, thereby generating a transmission signal θ. Here, an example of the combining method may be simple addition, and the transmission signal S° (t) that is the result of the combining is expressed as equation 3 below:

$${S}^{o} ( t ) = \frac{A}{\sqrt{2}} I ( t ) cos {ω}_{c} t - \frac{A}{\sqrt{2}} Q ( t ) sin {ω}_{c} t \qquad ( 3 )$$

In order to show the phase of the transmission signal θ, equation 3 can be simply expressed as equation 4 below:

S^{( )}=Acos(ω_{c}t+θ) (4)

According to the MPSK modulation method, M types of transmission signals exist, each having a different phase θ_{I} as shown in equation 5 below:

$${θ}_{i} = \frac{( 2 i - 1 ) π}{M} ; i = 1 , 2 , 3 , … , M \qquad ( 5 )$$

Here, i is an index determining each of the M types of transmission signals, and has a value from among 1, 2, . . . , M.

Meanwhile, symbol error rate (SER) performance is one of the measures of the transmission performance of a communication system. In order to improve the performance of the communication system under the same power consumption conditions, the SER must be lowered.

### SUMMARY OF THE INVENTION

The present invention provides an I/Q modulation apparatus and method capable of improving symbol error rate (SER) performance.

According to an aspect of the present invention, there is provided an I/Q modulation apparatus including: an oscillator generating a sine wave signal; an I/Q sine wave signal generation unit adjusting the phase of the sine wave signal based on I channel data and Q channel data, thereby generating an I channel sine wave signal and a Q channel sine wave signal such that a signal obtained by mixing a first signal and a second signal satisfies the condition that the mixed signal has a phase on a signal constellation diagram corresponding to the I and Q channel data, in which the first signal is obtained by applying the I channel data to the I channel sine wave signal and the second signal obtained by applying the Q channel data to the Q channel sine wave signal; and a transmission signal generation unit generating a transmission signal corresponding to the I and Q channel data, by respectively applying the I channel data and the Q channel data to the I channel sine wave signal and the Q channel sine wave signal.

The IQ sine wave signal generation unit may generate the I channel sine wave signal and the Q channel sine wave signal that satisfy the condition that the absolute value of the phase difference between the first signal and the second signal is 2 nπ (here, n is an integer equal to or greater than 0).

The IQ sine wave signal generation unit may generate the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0).

According to another aspect of the present invention, there is provided an I/Q modulation apparatus including: an oscillator generating a sine wave signal; an I/Q channel pulse generation unit generating I and Q channel pulses; an IQ sine wave signal generation unit adjusting the phase of the sine wave signal based on the I and Q channel pulses, thereby generating an I channel sine wave signal and a Q channel sine wave signal such that a signal obtained by mixing a first signal and a second signal satisfies the condition that the mixed signal has a phase on a signal constellation diagram corresponding to the I and Q channel pulses, in which the first signal is obtained by applying the I channel pulse to the I channel sine wave signal and the second signal obtained by applying the Q channel pulse to the Q channel sine wave signal; and a transmission signal generation unit generating a transmission signal corresponding to the I and Q channel pulses, by respectively applying the I channel pulse and the Q channel pulse to the I channel sine wave signal and the Q channel sine wave signal.

The IQ sine wave signal generation unit may generate the I channel sine wave signal and the Q channel sine wave signal that satisfy the condition that the absolute value of the phase difference between the first signal and the second signal is 2 nπ (here, n is an integer equal to or greater than 0).

The IQ sine wave signal generation unit may generate the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0).

According to another aspect of the present invention, there is provided an I/Q modulation method including: generating a sine wave signal; adjusting the phase of the sine wave signal based on I channel data and Q channel data, thereby generating an I channel sine wave signal and a Q channel sine wave signal such that a signal obtained by mixing a first signal and a second signal satisfies the condition that the mixed signal has a phase on a signal constellation diagram corresponding to the I and Q channel data, in which the first signal is obtained by applying the I channel data to the I channel sine wave signal and the second signal obtained by applying the Q channel data to the Q channel sine wave signal; and generating a transmission signal corresponding to the I and Q channel data, by respectively applying the I channel data and the Q channel data to the I channel sine wave signal and the Q channel sine wave signal.

In the generating of the I and Q sine wave signals, the I channel sine wave signal and the Q channel sine wave signal that satisfy the condition that the absolute value of the phase difference between the first signal and the second signal is 2 nπ (here, n is an integer equal to or greater than 0) may be generated.

In the generating of the I and Q sine wave signals, the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0) may be generated.

According to another aspect of the present invention, there is provided an I/O

modulation method including: generating a sine wave signal; generating I and Q channel pulses; adjusting the phase of the sine wave signal based on the I and Q channel pulses, thereby generating an I channel sine wave signal and a Q channel sine wave signal such that a signal obtained by mixing a first signal and a second signal satisfies the condition that the mixed signal has a phase on a signal constellation diagram corresponding to the I and Q channel pulses, in which the first signal is obtained by applying the I channel pulse to the I channel sine wave signal and the second signal obtained by applying the Q channel pulse to the Q channel sine wave signal; and generating a transmission signal corresponding to the I and Q channel pulses, by respectively applying the I channel pulse and the Q channel pulse to the I channel sine wave signal and the Q channel sine wave signal.

In the generating of the I and Q sine wave signals, the I channel sine wave signal and the Q channel sine wave signal that satisfy the condition that the absolute value of the phase difference between the first signal and the second signal is 2nπ(here, n is an integer equal to or greater than 0) may be generated.

In the generating of the I and Q sine wave signals, the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0) may be generated.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional I/Q modulation apparatus;

FIG. 2 illustrates an arbitrary transmission signal generated by an I/Q modulator in an X(t)-Y(t) rectangular coordinate system;

FIGS. 3A and 3B illustrate vector interpretations of equation 6 expressed as the sum of two sine wave signals;

FIGS. 4A through 4C illustrate concepts of phase adjustment values when a transmission signal is positioned in the first quadrant according to an embodiment of the present invention;

FIGS. 5A through 5C illustrate concepts of phase adjustment values when a transmission signal is positioned in the second quadrant according to an embodiment of the present invention;

FIGS. 6A through 6C illustrate concepts of phase adjustment values when a transmission signal is positioned in the third quadrant according to an embodiment of the present invention;

FIGS. 7A through 7C illustrate concepts of phase adjustment values when a transmission signal is positioned in the fourth quadrant according to an embodiment of the present invention;

FIGS. 8A and 8B are diagrams illustrating ranges of φ_{I} and φ_{Q} values according to an embodiment of the present invention;

FIGS. 9A through 9C are diagrams illustrating a method of modulation with respect to rotation of a signal according to an embodiment of the present invention;

FIG. 10 is a block diagram of an I/Q modulation apparatus according to an embodiment of the present invention;

FIGS. 11 and 12 are block diagrams of an IQ sine wave signal generation unit illustrated in FIG. 10 according to an embodiment of the present invention;

FIG. 13 is a block diagram of a transmission signal generation unit illustrated in FIG. 10 according to an embodiment of the present invention;

FIG. 14 is a block diagram of an I/Q modulation apparatus according to another embodiment of the present invention;

FIG. 15 is a block diagram of an I/Q channel pulse generation unit illustrated in FIG. 14 according to an embodiment of the present invention;

FIG. 16 is a block diagram of a transmission signal generation unit illustrated in FIG. 14 according to an embodiment of the present invention;

FIGS. 17 and 18 are block diagrams of an IQ sine wave signal generation unit illustrated in FIG. 14 according to an embodiment of the present invention;

FIGS. 19 and 20 illustrate the concept of an I/Q modulation apparatus according to an embodiment of the present invention;

FIG. 21 is a diagram illustrating an angle that is a base of an amplitude gain according to an embodiment of the present invention;

FIG. 22 is a signal constellation diagram of π/4-differential quadrature shift keying (π/4-DQPSK) according to an embodiment of the present invention;

FIG. 23 is a signal constellation diagram of 8-phase shift keying (8-PSK) illustrating a transmission signal generated by a conventional I/Q modulator and a transmission signal generated by an I/Q modulator according to an embodiment of the present invention under the same power consumption conditions;

FIG. 24 is a constellation diagram of an actual transmission signal when A=1, corresponding to the diagram illustrated in FIG. 23;

FIG. 25 is a diagram comparing the symbol error probability performance of the conventional 8-PSK modulation and the symbol error probability performance of the 8-PSK modulation according to the present invention under an additive white Gaussian noise environment;

FIG. 26 is a constellation diagram of an 8-APSK signal generated by two QPSK modulators according to an embodiment of the present invention;

FIG. 27 is the signal constellation diagram illustrated in FIG. 26 expressed in relation to a case where A_{I}=1 and A₂=4A_{I};

FIG. 28 is a flowchart illustrating an I/Q modulation method according to an embodiment of the present invention; and

FIG. 29 is a flowchart illustrating an I/Q modulation method according to another embodiment of the present invention.

### DETAILED DESCRIPTION OF THE INVENTION

The present invention will now be described more fully with reference to the accompanying drawings, in which exemplary embodiments of the invention are shown.

As described above, the conventional I/Q modulation apparatus fixes the phase of the I channel sine wave signal to 0 and the phase of the Q channel sine wave signal to π/2, and generates a transmission signal. Meanwhile, in a modulation apparatus and method according to an embodiment of the present invention as will be explained later, the phase of the I channel sine wave signal and the phase of the Q channel sine wave signal are adjusted according to the phases of I and Q channel data, to generate a transmission signal. Here, in a method of adjusting a phase according to an embodiment of the present invention, the phase of the I channel sine wave signal and the phase of the Q channel sine wave signal are adjusted such that when a first signal obtained by applying I channel data to the I channel sine wave signal, and a second signal obtained by applying Q channel data to the Q channel sine wave signal are combined, constructive interference of waves can occur. Accordingly, a transmission signal generated according to an I/Q modulation apparatus and method of the present invention has a much greater amplitude than a conventional transmission signal under the same power consumption conditions of an oscillator.

In order to explain the constructive interference of waves which is applied to the present invention, a signal S(t) that is the sum of two cosine functions, expressed as equation 6 below, will be considered:

S(t)=A_{I} cos(ω_{c}t+φᵢ)+A_{Q} cos(ω_{c}t+θ_{Q}) (6)

Here, A_{I} and A_{Q} are respectively I channel data and Q channel data, ωc is a carrier frequency, and φ_{I} and φ_{Q} are respectively phases of an I channel sine wave signal and a Q channel sine wave signal. As will be explained later, when the phase of a sine wave signal generated by an oscillator is 0 φ_{I} and φ_{Q} correspond respectively to the phase shift amounts of an I channel phase shifter and a Q channel phase shifter.

Here, S(t) can be arranged in a variety of ways according to an I/Q modulation technique on a signal constellation diagram. The principle of the present invention will be explained first under the conditions of a symmetric signal constellation diagram, and then, it will be explained that the present invention can be applied to asymmetric signal constellation diagrams. In a symmetric signal constellation diagram, each signal that can be expressed by S(t) is symmetric about an I axis and a Q axis.

If an addition formula of trigonometric functions, cos(α+β)=cosα*cosβ-sinα*sinβ, is used, equation 6 can be expressed as equation 7 below:

S(t)=(A_{I} cos φ_{I}+A_{Q} cos φ_{Q})cos ω_{c}t−(A_{I} sin φ_{I}+A_{Q} sin φ_{Q})sin ω_{c}t (7)

In order to plot a signal constellation diagram of S(t), orthogonal basis functions as equations θ and 9 below are defined, and by using these orthogonal basis functions, equation 7 can be expressed as equation 10 below:

X(t)=cos ω_{c}t (8)

Y(t)=−sin ω_{c}t (9)

S(t)=(A_{I} cos φ_{I}+A_{Q} cos φ_{Q})X(t)+(A_{I} sin φ_{I}+A_{Q} sin φ_{Q})Y(t) (10)

Here, the amplitude |S(t)| of S(t) is calculated as equation 11 below:

$$\begin{matrix}\vert S ( t ) \vert = \sqrt{{( {A}_{l} cos {φ}_{l} + {A}_{Q} cos {φ}_{Q} )}^{2} + {( {A}_{l} sin {φ}_{l} + {A}_{Q} sin {φ}_{Q} )}^{2}} \\ = \sqrt{{A}_{l}^{2} + {A}_{Q}^{2} + 2 {A}_{l} {A}_{Q} ( cos {φ}_{Q} cos {φ}_{l} + sin {φ}_{Q} sin {φ}_{l} )}\end{matrix} \qquad ( 11 )$$

If a trigonometric formula, cosα*cosβ+sinα*sinβ=cos(α−β), is used, equation 11 can be expressed as equation 12 below:

|S(t)|=\sqrt{A_{I}²+A_{Q}²+2A_{I}A_{Q} cos(φ_{Q}−φ_{I})} (12)

Referring to equation 12, it can be learned that the amplitude |S(t)| relies on φ_{I}−φ_{Q}.

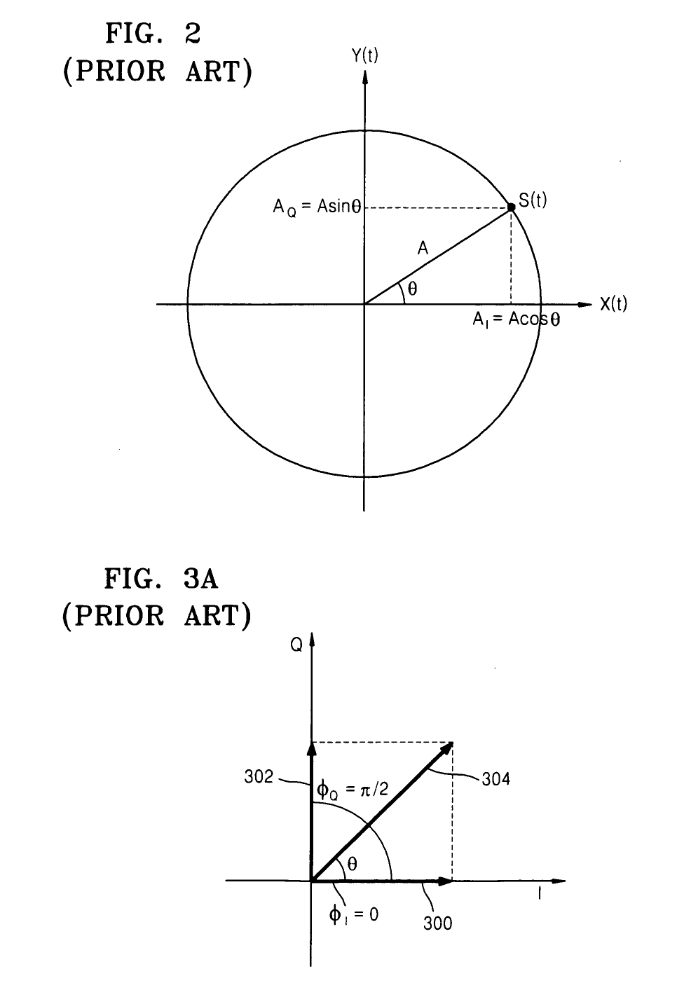

FIG. 2 illustrates an arbitrary transmission signal generated by an I/Q modulator in an X(t)-Y(t) rectangular coordinate system.

Referring to FIG. 2, when an arbitrary signal S(t) is expressed by amplitude A and a phase θ, values on the X(t)-axis and Y(t)-axis corresponding to S(t) are respectively A_{I}=Acosθ and A_{Q}=Asinθ. For example, if the phase θ corresponding to A_{I} and A_{Q} is π/4, A_{I} and A_{Q} are both equal to A/\sqrt{2}.

If A_{I}=Acosθ and A_{Q}=Asinθ are applied for substitution in equations 6 and 12, S(t) and its amplitude |S(t)| are respectively expressed as equations 13 and 14, below:

S(t)=A costθ cos(ω_{c}t+φᵢ)+A sin θ cos(ω_{c}t+φ_{Q}) (13)

|S(t)|=\sqrt{A²+2A² sin θ cos θ cos(φ_{Q}−φ_{I})} (14)

Referring to equation 14, it can be known that the amplitude |S(t)| varies with respect to sinθ cosθ and cos(φ_{Q}-φ_{I}). The value of sinθ cosθ becomes positive or negative according to the phase θ of the signal S(t). Accordingly, if sinθ cosθ is positive, φ_{Q} and φ_{I} are adjusted such that cos(φ_{Q}-φ_{I}) becomes ‘+1’, and if sinθ cosθ is negative, φ_{Q} and φ_{I} are adjusted such that cos(φ_{Q}-φ_{I}) becomes ‘−1’. In this way, the amplitude |S(t)| can be maximized. This adjustment method achieves the result of using constructive interference of waves. A detailed adjustment method will now be explained. In the case of a phase θ that makes sinθ cosθ positive, |φ_{Q}-φ_{I}| (the absolute value of the difference between phases) is adjusted to 2 nπ, and in the case of a phase θ that makes sinθ cosθ negative, |φ_{Q}-φ_{I}| is adjusted to 2mπ+π. Then, the constructive interference effect described above can be maximized. Here, m and n are integers equal to or greater than zero. In the present specification, for convenience, the range of values that a phase can be is limited to [0,2π], and in the above case, n corresponds to 0 and m corresponds to 0.

However, even when n is not 0 or m is not 0, the range is included in the scope of the present invention, which can be easily understood by a person skilled in the art relevant to the present invention. Here, the fact that the range of x is included in [a1,b1], [a2,b2), (a3,b3], and (a4,b4) indicates that a1<x<b1, a2<x<b2, a3<x<b3 and a4<x<b4.

Meanwhile, according to the conventional I/Q modulation apparatus, since |φ_{Q}−φ_{I}|=π/2, cos(φ_{Q}−φ_{I})=0. Accordingly, the amplitude |S(t)| is maintained to be always A, and there is no constructive interference effect that increases the amplitude.

This characteristic of constructive interference will now be explained in relation to the cases where the phase θ of S(t) is in the first quadrant, in the second quadrant, in the third quadrant, and in the fourth quadrant.

First, the case where the phase θ of S(t) is in the first quadrant or in the third quadrant will be explained. In this case, since sinθ cosθ is positive, if the value of |φ_{Q}−φ_{I}| is set to 0, cos(φ_{Q}−φ_{I})=1. Accordingly, the amplitude |S(t)| of equation 14 can be expressed as equation 15 below:

$$\vert S ( t ) \vert = \sqrt{{A}^{2} + 2 {A}^{2} sin θcos θ} ; \\ 0 < θ \leq \frac{π}{2} or π < θ \leq \frac{3 π}{2} \qquad ( 15 )$$

Secondly, the case where the phase θ of S(t) is in the first quadrant or the fourth quadrant will be explained. In this case, since sinθ cosθ is negative, if the value of |φ_{Q}−φ_{I}| is set to π, cos(φ_{Q}−φ_{I})=−1. Accordingly, the amplitude |S(t)| of equation 14 can be expressed as equation 16 below:

$$\vert S ( t ) \vert = \sqrt{{A}^{2} - 2 {A}^{2} sin θcos θ } ; \\ \frac{π}{2} < θ \leq π or \frac{3 π}{2} < θ \leq 2 π \qquad ( 16 )$$

If a trigonometric formula 2 sinα*cosβ=sin2α is applied to equations 15 and 16, it can be known that the amplitude |S(t)| of the signal S(t) is \sqrt{1+|sin 2θ|A}.

It should be noted that the cases where the phase is 0, π/2, π, and 3π/2 are excluded from the assumptions of the present signal constellation diagram; that is, when signals arranged in a signal constellation diagram are also on the X(t)-axis or on the Y(t)-axis, the second term in the root of each of equations 15 and 16 is always 0. Accordingly, the amplitude is always A and it seems that no amplitude increase effect occurs. However, this is only because of the limits in expressing trigonometric functions, and even when signals arranged in a signal constellation diagram fall on the X(t)-axis or Y(t)-axis, an amplitude increasing effect does actually occur, as will be explained later with reference to table 3.

As described above, if the value of |φ_{Q}−φ_{I}| (the absolute value of the phase difference included in cos(φ_{Q}−φ_{I})) is adjusted to 0 or π according to the quadrant to which the phase θ of S(t) belongs, the amplitude |S(t)| can be maximized. Table 1 below illustrates the value of |φ_{Q}−φ_{I}| adjusted with respect to the phase θ of S(t).

TABLE 1

| Classification | \| φ_{Q} − φ_{I} \| |
|---|---|
| θ Quadrant I | 0 |
| θ Quadrant II | π |
| θ Quadrant III | 0 |
| θ Quadrant IV | π |

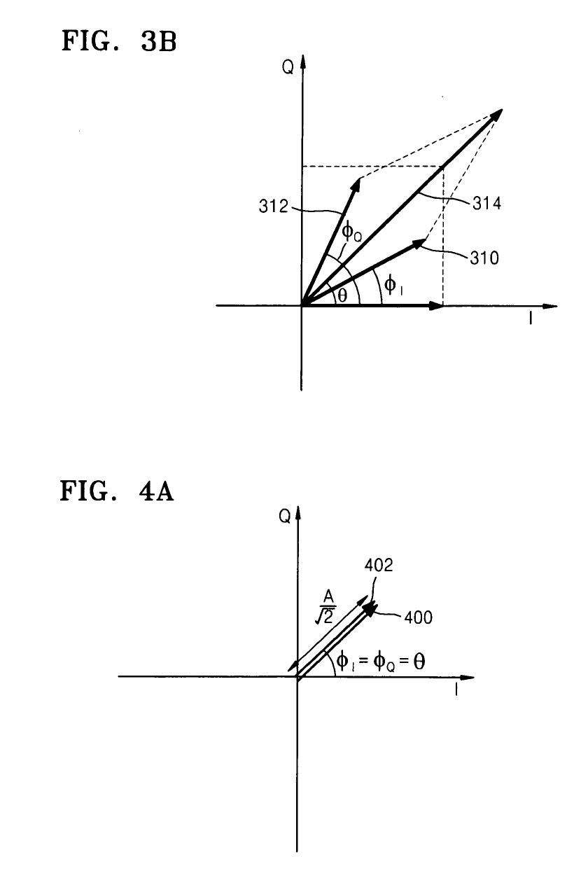

FIGS. 3A and 3B illustrate vector interpretations of equation 6 expressed as the sum of two sine wave signals. The vector interpretations will be explained assuming that a transmission signal based on data to be transmitted is in the first quadrant, that is, θ belongs to the range (θ, π/2).

FIG. 3A illustrates a process in a vector expression, of generating a signal according to the conventional method, and FIG. 3B illustrates a process in a vector expression, of generating a signal having a constructive interference effect according to an embodiment of the present invention.

Referring to FIG. 3A, when both A_{I} and A_{Q} are greater than 0, A_{I} cos(ω_{c}t+φᵢ) of equation 6 is expressed as a first vector 300 whose magnitude is A_{I} and whose direction is φ_{I}=0, and A_{Q} cos(ω_{c}t+φ_{Q}) of equation 6 is expressed as a second vector 302 whose magnitude is A_{Q} and whose direction is φ_{Q}=0. Also, a third vector 304 corresponding to S(t) is the vector sum of the first vector 300 and the second vector 302, and the direction of the third vector 304 satisfies the aimed condition of phase θ, that is the direction on a signal constellation diagram. In this case, if A_{I}=A/\sqrt{2} and A_{Q}=A/\sqrt{2}, the magnitude and direction of the third vector 304 are respectively A and θ=π/4, and the third vector 304 corresponds to a transmission signal which has amplitude A and a phase of π/4.

Likewise, referring to FIG. 3B, when both A_{I} and A_{Q} are greater than 0, A_{I} cos(ω_{c}t+φᵢ) of equation 6 is expressed as a first vector 310 whose magnitude is A_{I} and whose direction is φ_{I}, and A_{Q} cos(ω_{c}t+φ_{Q}) of equation 6 is expressed as a second vector 312 whose magnitude is A_{Q} and whose direction is φ_{Q}. Also, a third vector 314 corresponding to S(t) is the vector sum of the first vector 310 and the second vector 312, and the direction of the third vector 314 satisfies a phase condition that the phase is an aimed direction on a signal constellation diagram.

Referring to FIG. 3B, it can be known that if phases φ_{I} and φ_{Q} are adjusted such that a condition |φ_{Q}−φ_{I}|<π/2 is satisfied, the third vector 314 having a magnitude greater than that of the third vector 304 illustrated in FIG. 3A can be obtained under the condition of the same A_{I} and A_{Q}, while also satisfying an aimed direction condition. For example, under the condition that A_{I}=A/\sqrt{2} and A_{Q}=A/\sqrt{2}, according to FIG. 3B, the direction of the third vector 314 is θ=π/4, that is, the direction satisfies an aimed direction, and the magnitude of the third vector 314 is greater than A. The third vector 314 having these characteristic corresponds to a transmission signal whose amplitude is greater than A and whose phase is π/4.

This shows that when the absolute value of the phase difference between a first signal obtained by applying I channel data to an I channel sine wave signal and a second signal obtained by applying Q channel data to a Q channel sine wave signal is less than π/2, which is the absolute value of the phase difference according to the conventional modulation method, a transmission signal having a greater amplitude than that according to the conventional modulation method can be obtained.

In FIGS. 3A and 3B, the principle of increasing amplitude is explained with reference to a transmission signal positioned in the first quadrant. However, even when the transmission signal is positioned in the remaining quadrants, the principle can be explained in the same manner. That is, in the conventional modulation method, the absolute value of the phase difference of the first signal and the second signal is π/2, while in the modulation method according to the present invention, the absolute value of the phase difference of the first signal and the second signal is less than π/2. According to this condition of the absolute value of the phase difference, an amplitude gain occurs, and when the absolute value of the phase difference is 0, the maximum amplitude gain can be obtained.

If the absolute value of the phase difference between the first signal and the second signal is greater than π/2, the amplitude becomes less than that of the conventional modulation method.

In order to apply the present invention, in addition to the condition of the absolute value of the phase difference, described above, the phase of the vector sum should satisfy θ having the correct phase for a transmission signal. Then, normal transmission and reception can be performed without changing a conventional system. That is, the phase of a transmission signal obtained by combining the first signal and the second signal should be the phase θcorresponding to the I channel data and the Q channel data.

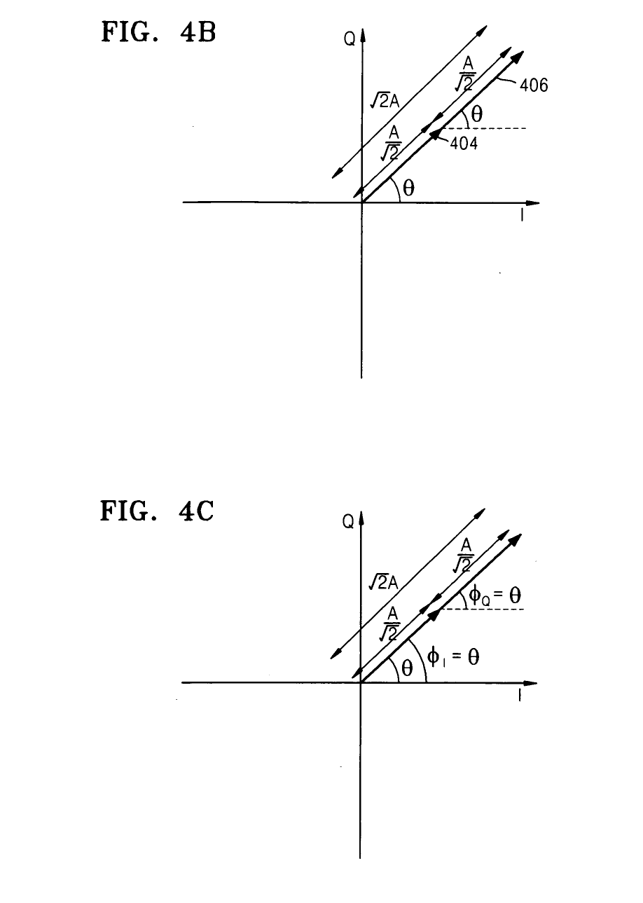

A process of obtaining phase φ_{I} and φ_{Q} values that increase the amplitude |S(t)| according to the present invention will now be explained with reference to FIGS. 4A through 7C in relation to the cases where the signal S(t) is in the first quadrant, in the second quadrant, in the third quadrant, and in the fourth quadrant. Here, the φ_{I} and φ_{Q} values illustrated in FIGS. 4A through 7C are based on an assumption that rotation angles are measured counterclockwise. It can be easily understood by a person skilled in the art that even when rotation angles are measured clockwise, the φ_{I} and φ_{Q} values adjusted according to the present invention can be obtained on the same principle.

Also, for convenience, FIGS. 4A through 7C will be explained on the assumption that each phase is in the range of [0,2π]. It can be easily understood by a person skilled in the art that other embodiments in which a phase is positioned outside that range are also included in the scope of the present invention, when the cyclic characteristics of sine waves are considered.

FIGS. 4A through 4C illustrate concepts of phase adjustment values when a transmission signal is positioned in the first quadrant according to an embodiment of the present invention.

FIG. 4A illustrates an I channel sine wave signal 400 obtained by shifting a sine wave signal generated by an oscillator such that φ_{I}=θ, and a Q channel sine wave signal 402 obtained by shifting the sine wave signal such that φ_{Q}=θ. FIG. 4B illustrates a first signal 404 obtained by multiplying the I channel sine wave signal 400 by an I channel data value (Iₖ=a positive number), and a second signal 406 obtained by multiplying the Q channel sine wave signal 402 by a Q channel data value (Qₖ=a positive number).

A process of obtaining the φ_{I} and φ_{Q} values will now be explained. In FIG. 4B, the phase of a transmission signal (not shown) obtained by adding the first signal 404 and the second signal 406 should be θ. There are infinite phases of the first signal 404 and the second signal 406 that make the phase of the transmission signal θ. However, when the phases of the first signal 404 and the second signal 406 are both θ, the phase values maximize the amplitude of the transmission signal, i.e. the amplitude according to the sum of the first signal 404 and the second signal 406. In this case, the absolute value of the phase difference between the first signal 404 and the second signal 406 is θ.

According to the embodiment of FIGS. 4A and 4B, since the I channel sine wave signal 400 and the Q channel sine wave signal 402 are respectively multiplied by the positive numbers Iₖ and Qₖ, thereby generating the first signal 404 and the second signal 406, the phase of the I channel sine wave signal 400 is the same as the phase of the first signal 404, and the phase of the Q channel sine wave signal 402 is the same as the phase of the second signal 406. Accordingly, the phase φ_{I} of the I channel sine wave signal 400 is θ, and the phase φ_{Q} of the Q channel sine wave signal 402 is also θ.

In the example of FIGS. 4A and 4B, if the amplitude of the sine wave signal generated by the oscillator is A, both the amplitude of the I channel sine wave signal 400 and the amplitude of the Q channel sine wave signal 402 are A/\sqrt{2}, and the amplitude of the transmission signal generated as the sum of the first signal 404 and the second signal 406 is \sqrt{1+|sin 2θ|}A. Accordingly, with the condition of FIGS. 4A and 4B, the modulation method of the present invention provides an increase \sqrt{1+|sin 2θ|} in the amplitude compared to the conventional modulation method.

Additionally, an intuitive method of determining the phase φ_{I} and φ_{Q} values by geometrically measuring an angle will now be explained with reference to FIG. 4C. When I and Q channel data are positioned in the first quadrant, the I channel sine wave signal and the Q channel sine wave signal are multiplied by positive numbers, thereby generating a first signal and a second signal. Accordingly, in order to determine the phases φ_{I} and φ_{Q}, the phases of the first signal and the second signal need to be measured with reference to the positive part of the X-axis, that is a reference for measuring the phase θ of the transmission signal. In this case, as illustrated in FIG. 4C, φ_{I}=θ and φ_{Q}=θ.

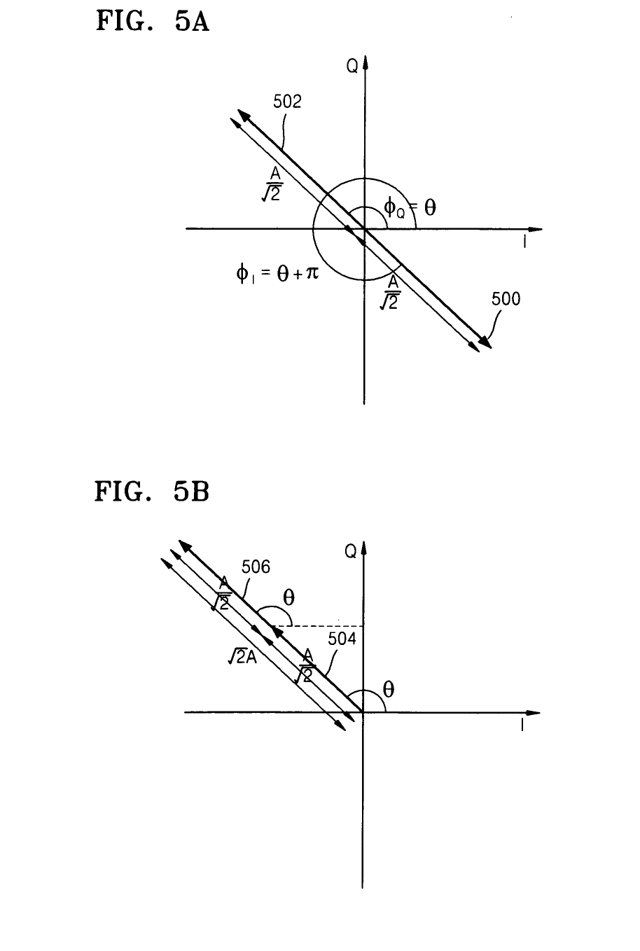

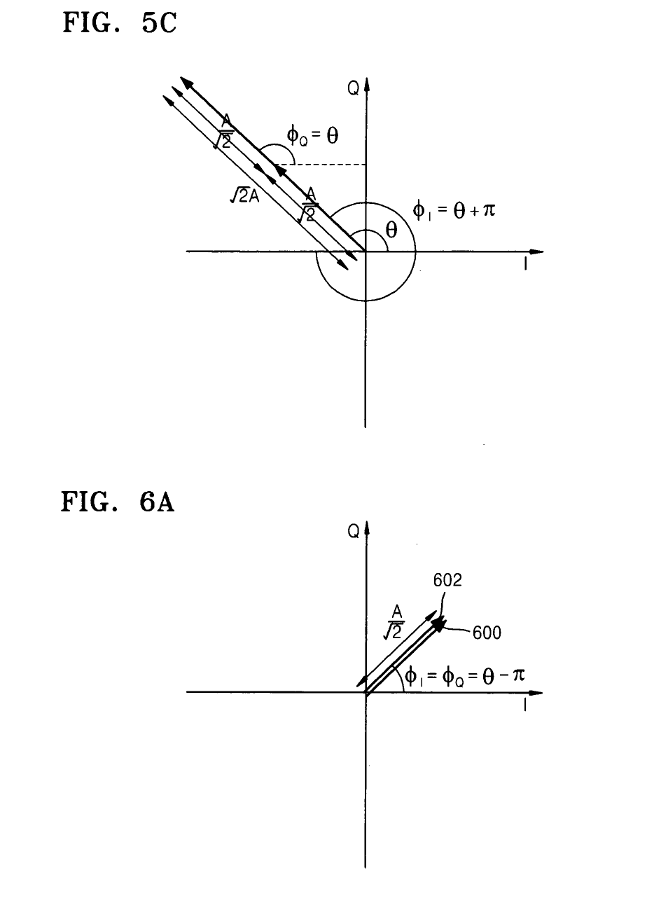

FIGS. 5A through 5C illustrate concepts of phase adjustment values when a transmission signal is positioned in the second quadrant according to an embodiment of the present invention.

FIG. 5A illustrates an I channel sine wave signal 500 obtained by shifting a sine wave signal generated by an oscillator such that φ_{I}=θ+π according to table 2, and a Q channel sine wave signal 502 obtained by shifting the sine wave signal such that φ_{Q}=θ according to table 2. FIG. 5B illustrates a first signal 504 obtained by multiplying the I channel sine wave signal 500 by an I channel data value (Iₖ=a negative number) in the second quadrant, and a second signal 506 obtained by multiplying the Q channel sine wave signal 502 by a Q channel data value (Qₖ=a positive number) in the second quadrant. The process of obtaining the φ_{I} and φ_{Q} values is similar to the process explained above with reference to FIGS. 4A through 4C.

In FIG. 5B, the phase of a transmission signal (not shown) obtained by adding the first signal 504 and the second signal 506 should be θ. When the phases of the first signal 404 and the second signal 406 are both θ, the phase values make the phase of the transmission signal θ, and maximize the amplitude of the transmission signal. In this case, the absolute value of the phase difference between the first signal 504 and the second signal 506 is 0.

Under the condition that I and Q channel data values (Iₖ=a negative number, Qₖ=a positive number) are positioned in the second quadrant, since the first signal 504 is generated by multiplying the I channel sine wave signal 500 by the negative number, the absolute value of the phase difference between the I channel sine wave signal 500 and the first signal 504 is π. Meanwhile, since the second signal 506 is generated by multiplying the Q channel sine wave signal 502 by the positive number, the absolute value of the phase difference between the Q channel sine wave signal 502 and the second signal 506 is 0. Accordingly, the phase φ_{I} of the I channel sine wave signal 500 is θ+π, and the phase φ_{Q} of the Q channel sine wave signal 502 is θ. Though the phases of the I channel sine wave signal 500 and the Q channel sine wave signal 502 themselves are different, the phases of the first signal 504 and the second signal 506 become the same through multiplication with the I and Q channel data values, and thus the amplitude increases to \sqrt{1+|sin 2θ|} times that of the conventional modulation method, by constructive interference.

Additionally, an intuitive method of determining the phase φ_{I} and φ_{Q} values by geometrically measuring an angle will now be explained with reference to FIG. 5C. When I and Q channel data are positioned in the second quadrant, a first signal is generated by multiplying an I channel sine wave signal by a negative number. Accordingly, it should be considered that the phase φ_{I} changes by π as the result of the multiplication. For this, φ_{I} needs to be measured with reference to the negative part of the X-axis, which is rotated by π from the positive part of the X-axis, instead of the positive portion of the X-axis that is a reference for measuring the phase of a transmission signal. Referring to FIG. 5C, the φ_{I} value is θ+π. Meanwhile, since a second signal is generated by multiplying a Q channel sine wave signal by a positive number, the result of the multiplication does not change the phase φ_{Q}. Accordingly, in this case, φ_{Q} needs to be measured with reference to the positive part of the X-axis that is a reference for measuring the phase of the transmission signal. Referring to FIG. 5C, the phase φ_{Q} is θ.

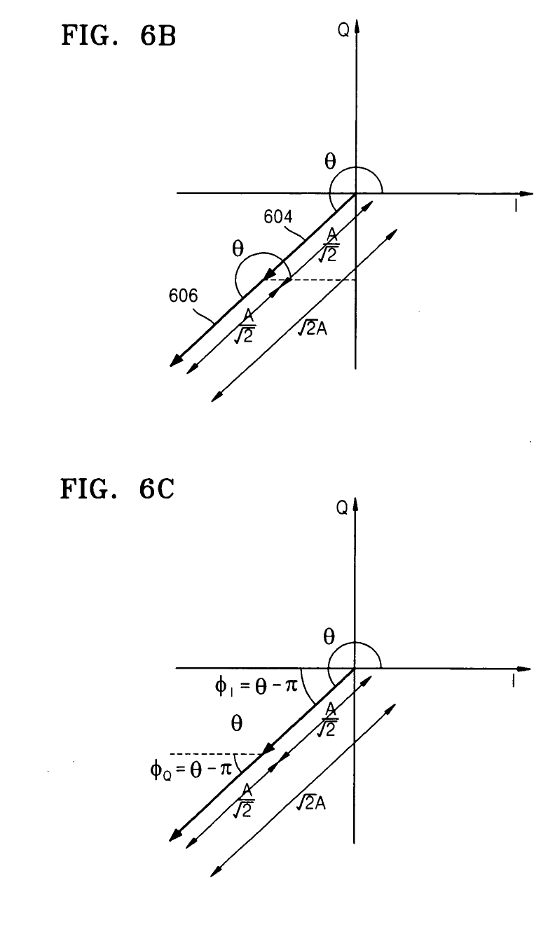

FIGS. 6A through 6C illustrate concepts of phase adjustment values when a transmission signal is positioned in the third quadrant according to an embodiment of the present invention.

FIG. 6A illustrates an I channel sine wave signal 600 obtained by shifting a sine wave signal generated by an oscillator such that φ_{I}=θ−π according to table 2, and a Q channel sine wave signal 602 obtained by shifting the sine wave signal such that φ_{Q}=θ−π according to table 2. FIG. 6B illustrates a first signal 604 obtained by multiplying the I channel sine wave signal 600 by an I channel data value (Iₖ=a negative number) in the third quadrant, and a second signal 606 obtained by multiplying the Q channel sine wave signal 602 by a Q channel data value (Qₖ=a negative number) in the third quadrant. The process of obtaining the φ_{I} and φ_{Q} values is similar to the process explained above with reference to FIGS. 4A through 4C.

In FIG. 6B, the phase of a transmission signal (not shown) obtained by adding the first signal 604 and the second signal 606 should be θ. When the phases of the first signal 604 and the second signal 606 are θ each, the phase values make the phase of the transmission signal θ, and make the amplitude of the transmission signal a maximum. In this case, the absolute value of the phase difference between the first signal 604 and the second signal 606 is 0.

Under the condition that I and Q channel data values (Iₖ=a negative number, Qₖ=a negative number) are positioned in the third quadrant, since the first signal 604 is generated by multiplying the I channel sine wave signal 600 by the negative number, the absolute value of the phase difference between the I channel sine wave signal 600 and the first signal 604 is π. Meanwhile, since the second signal 606 is generated by multiplying the Q channel sine wave signal 602 by the negative number, the absolute value of the phase difference between the Q channel sine wave signal 602 and the second signal 606 is π. Accordingly, the phase φ_{I} of the I channel sine wave signal 600 is θ+π, and the phase φ_{Q} of the Q channel sine wave signal 602 is θ+π. In this case, the phases of the I channel sine wave signal 600 and the Q channel sine wave signal 602 are the same, and the phases of the first signal 604 and the second signal 606 become the same through multiplication with the I and Q channel data values, of the same sign. Accordingly, the amplitude increases to \sqrt{1+|sin 2θ|} times that of the conventional modulation method, by constructive interference.

Additionally, an intuitive method of determining the phase φ_{I} and φ_{Q} values by geometrically measuring an angle will now be explained with reference to FIG. 6C. When I and Q channel data are positioned in the third quadrant, a first signal is generated by multiplying an I channel sine wave signal by a negative number. Accordingly, it should be considered that the phase φ_{I} changes by π as the result of the multiplication. For this, φ_{I} needs to be measured with reference to the negative part of the X-axis, which is rotated by π from the positive part of the X-axis, instead of the positive portion of the X-axis that is a reference for measuring the phase of a transmission signal. Referring to FIG. 5C, the φ_{I} value is θ-π. Likewise, since a second signal is generated by multiplying a Q channel sine wave signal by a negative number, the φ_{Q} value of the Q channel is explained in the same manner.

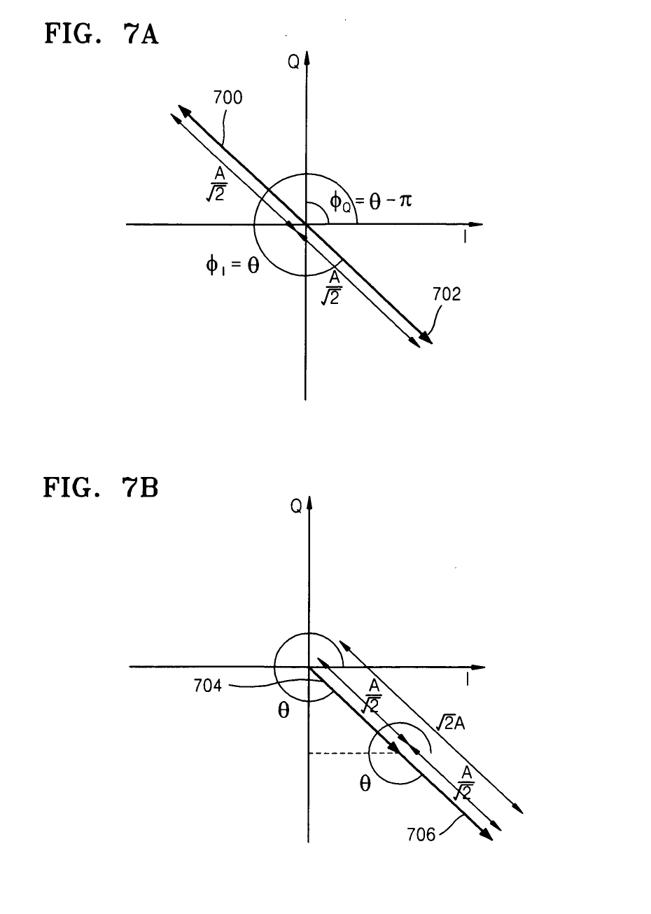

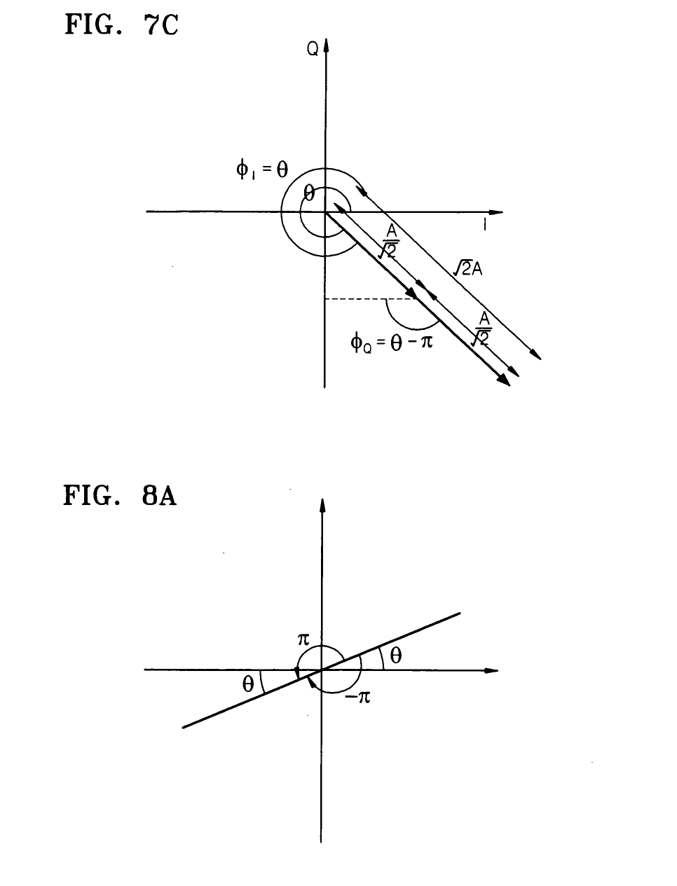

FIGS. 7A through 7C illustrate concepts of phase adjustment values when a transmission signal is positioned in the fourth quadrant according to an embodiment of the present invention.

FIG. 7A illustrates an I channel sine wave signal 700 obtained by shifting a sine wave signal generated by an oscillator such that φ_{I}=θ according to table 2, and a Q channel sine wave signal 702 obtained by shifting the sine wave signal such that φ_{Q}=θ−π according to table 2. FIG. 7B illustrates a first signal 704 obtained by multiplying the I channel sine wave signal 700 by an I channel data value (Iₖ=a positive number) in the fourth quadrant, and a second signal 706 obtained by multiplying the Q channel sine wave signal 702 by a Q channel data value (Qₖ=a negative number) in the fourth quadrant. The process of obtaining the φ_{I} and φ_{Q} values is similar to the process explained above.

In FIG. 7B, the phase of a transmission signal (not shown) obtained by adding the first signal 704 and the second signal 706 should be θ. When the phases of the first signal 704 and the second signal 706 are both θ, the phase values make the phase of the transmission signal θ, and maximize the amplitude of the transmission signal. In this case, the absolute value of the phase difference between the first signal 704 and the second signal 706 is 0.

Under the condition that I and Q channel data values (Iₖ=a positive number, Qₖ=a negative number) are positioned in the fourth quadrant, since the first signal 704 is generated by multiplying the I channel sine wave signal 700 by the positive number, the absolute value of the phase difference between the I channel sine wave signal 700 and the first signal 704 is 0. Meanwhile, since the second signal 706 is generated by multiplying the Q channel sine wave signal 702 by the negative number, the absolute value of the phase difference between the Q channel sine wave signal 702 and the second signal 706 is π. Accordingly, the phase φ_{I} of the I channel sine wave signal 700 is θ, and the phase φ_{Q} of the Q channel sine wave signal 702 is θ−π. Though the phases of the I channel sine wave signal 700 and the Q channel sine wave signal 702 themselves are different, the phases of the first signal 704 and the second signal 706 become the same through multiplication with the I and Q channel data values, and thus the amplitude increases to \sqrt{1+|sin 2θ|} times that of the conventional modulation method, by constructive interference.

Additionally, an intuitive method of determining the phase φ_{I} and φ_{Q} values by geometrically measuring an angle will now be explained with reference to FIG. 7C. When I and Q channel data are positioned in the fourth quadrant, a second signal is generated by multiplying a Q channel sine wave signal by a negative number. Accordingly, it should be considered that the phase φ_{Q} changes by π as the result of the multiplication. For this, φ_{Q} needs to be measured with reference to the negative part of the X-axis, which is rotated by π from the positive part of the X-axis, instead of the positive portion of the X-axis that is a reference for measuring the phase of a transmission signal. Referring to FIG. 7C, the φ_{Q} value is θ−π. Meanwhile, since a first signal is generated by multiplying an I channel sine wave signal by a positive number, the result of the multiplication does not change the phase φ_{I}. Accordingly, in this case, φ_{I} needs to be measured with reference to the positive part of the X-axis that is a reference for measuring the phase of the transmission signal. Referring to FIG. 7C, the phase value φ_{I} is θ.

According to the derivation processes described above, two phase values cl), and φ_{Q} relative to the phase value θ of signal S(t) can be illustrated with respect to the position of θ in any one of the first through fourth quadrants, as shown in table 2. Here, the values of φ_{I} and φ_{Q} in table 2 are based on the assumption that rotation angles are measured counterclockwise and the phases are in the range of [0,2π].

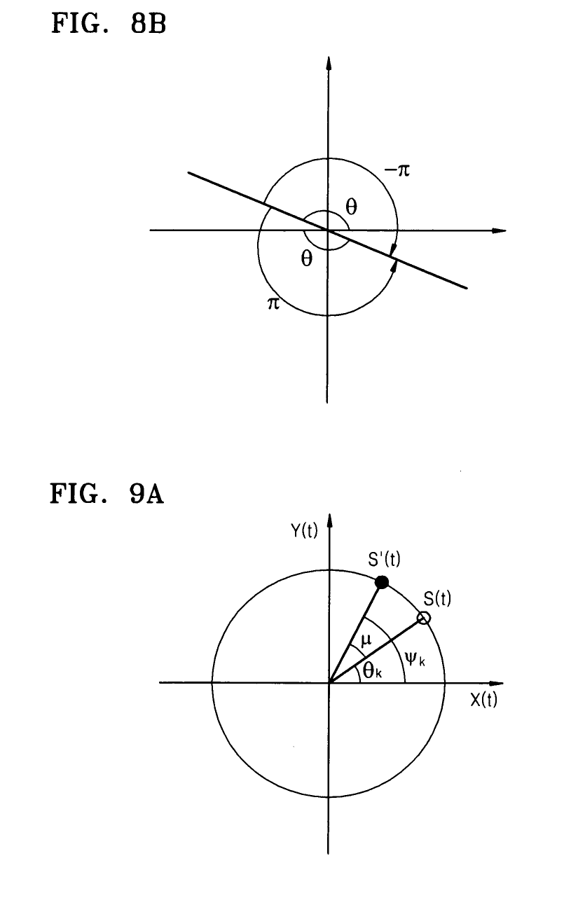

FIGS. 8A and 8B are diagrams illustrating ranges of φ_{I} and φ_{Q} values according to an embodiment of the present invention.

Referring to FIGS. 8A and 8B, whether θ is added to +π or −π, the result is the same. Accordingly, for convenience, in table 2, the values of φ_{I} and φ_{Q} are in the range of [0,2π].

TABLE 2

| Classification | Range of θ | φ_{I} | φ_{Q} |
|---|---|---|---|
| θ Quadrant I | 0 < θ ≦ π/2 | θ | θ |
| θ Quadrant II | π/2 < θ ≦ π | θ + π | θ |
| θ Quadrant III | π < θ ≦ 3π/2 | θ − π | θ − π |
| θ Quadrant IV | 3π/2 < θ ≦ 2π | θ | θ − π |

As described above, in each quadrant illustrated in table 2, φ_{I} and φ_{Q} are obtained such that the phase of a final transmission signal can be maintained and the amplitude of the transmission signal can be maximized, and can satisfy the phase difference condition to maximize the amplitude of a final transmission signal illustrated in table 1.

Referring to FIG. 3A illustrating the conventional modulation method and FIGS. 4A, 5A, 6A, and 7A illustrating the modulation method according to the present invention, the modulation method of the present invention will now be compared with the conventional modulation method. Referring to FIG. 3A, φ_{I} and COQ are fixed as φ_{I}, φ_{Q})=(0,π2) regardless of the phase of an input signal determined as input data (Iₖ,Qₖ). However, in FIGS. 4A, 5A, 6A, and 7A according to the modulation method of the present invention, (φ_{I}, φ_{Q}) are adjusted to values in table 2 with respect to the phase of an input signal determined as input data (Iₖ,Qₖ). Whether the modulation method of the present invention or the conventional modulation method is used, the phase corresponding to an input data signal is applied directly to a carrier wave in a final transmission signal. However, according to the present invention the amplitude of the final transmission signal is greater than that of the conventional modulation method. In addition, according only to table 2 it seems that 4 pairs of (φ_{I}, φ_{Q}) exist, but, as can be predicated from FIGS. 4A, 5A, 6A, and 7A, the pair of (φ_{I}, φ_{Q}) in the first quadrant is the same as the pair of (φ_{I}, φ_{Q}) in the third quadrant, and the pair of (φ_{I}, φ_{Q}) in the second quadrant is the same as the pair of (φ_{I}, φ_{Q}) in the fourth quadrant. Accordingly, two pairs of (φ_{I}, φ_{Q}) are actually implemented. This is because, as explained above in relation to the intuitive method of geometrically obtaining an angle, in the first quadrant, φ_{I} and φ_{Q} are measured with reference to the positive part of the X-axis, and in the fourth quadrant, φ_{I} and φ_{Q} are measured with reference to the positive part of the X-axis. Accordingly, the values of φ_{I} and φ_{Q} actually measured in the two quadrants become identical to each other. That is, as illustrated in FIG. 8A, the pair (φ_{I}, φ_{Q}) in the first quadrant and the pair (φ_{I}, φ_{Q}) in the third quadrant are inversely symmetric to each other about the origin. For the same reason, the pair (φ_{I}, φ_{Q}) in the second quadrant and the pair (φ_{I}, φ_{Q}) in the fourth quadrant have the same values, and this inversely symmetric relationship is illustrated in FIG. 8B. In terms of convenience of implementation, a smaller number of types of phase shift amounts is easier to implement.

The characteristics of a first signal and a second signal forming a transmission signal will now be explained. In the conventional method, (φ_{I}, φ_{Q}) is fixed to (φ_{I}, φ_{Q})=(0,π/2) irrespective of the I channel data and Q channel data, and the first signal and the second signal are always orthogonal and different to each other. Accordingly, the amplitude of a transmission signal obtained as the sum of the first signal and the second signal is less than the maximum amplitude by constructive interference according to the present invention. In the present invention, the pair of (φ_{I}, φ_{Q}) varies with respect to the I channel data and the Q channel data, thereby making the phase of the first signal the same as the phase of the second signal and thus making the first signal the same as the second signal. Accordingly, the amplitude of the transmission signal that is the sum of the first signal and the second signal is extended to a maximum by constructive interference, and becomes \sqrt{1+|sin 2θ|} times greater than that of the conventional method. If the phase difference between the first signal and the second signal is less than π/2, that is the phase of the conventional method, and greater than 0, that is the phase giving the maximum amplitude according to the present invention, the amplitude becomes greater than A, that is the amplitude according to the conventional method, and less than \sqrt{1+|sin 2θ|}A.

A demodulation process on the reception side can directly use a conventional demodulation method. This is because when the same power as used for the conventional modulation method is used for the modulation method according to the present invention, and noise in transmission and reception is ignored, the phase of a received signal according to the conventional modulation method is the same as the phase of a received signal according to the present invention, and the only difference is that the amplitude of the received signal according to the modulation method of the present invention is \sqrt{1+|sin 2θ|} times greater than that of the conventional modulation method. Also, when the power used for the modulation method of the present invention is less than that for the conventional modulation method, such that the amplitude of a transmission signal according to the modulation method of the present invention is the same as that according to the conventional modulation method, the two received signals according to the two methods are the same in terms of amplitude and phase.

So far, the concept of the present invention has been described on the assumption that each signal falls not on an axis but in a quadrant, and all signals in a constellation diagram are symmetric about the axes. Since a transmission signal that does not meet these assumptions can be expressed as a signal S(t) that is obtained by shifting the phase of the signal S(t) by an arbitrary amount p, the amplitude increasing effect by constructive interference occurs in the same manner.

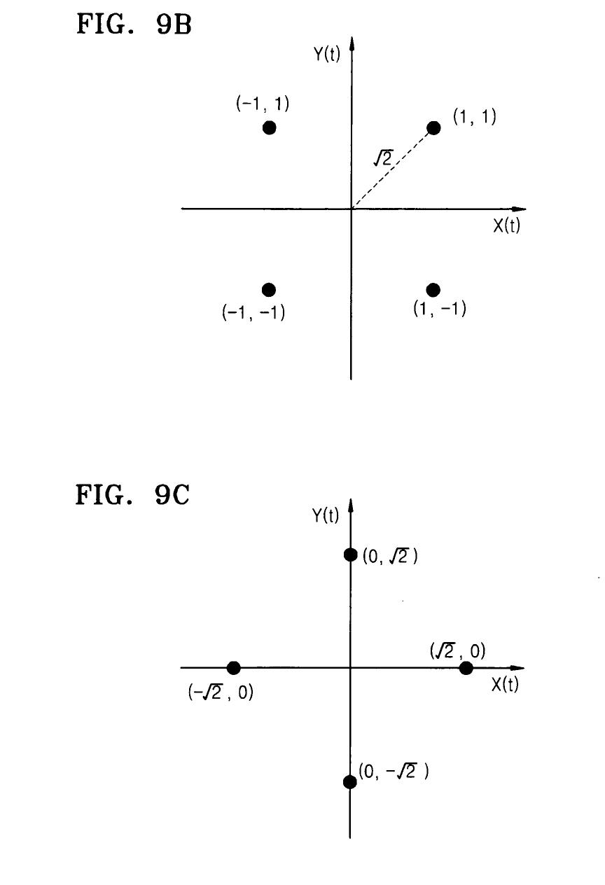

FIGS. 9A through 9C are diagrams illustrating a method of modulation with respect to rotation of a signal according to an embodiment of the present invention.

As illustrated in FIG. 9A, a signal S*(t) is obtained by rotating an original signal S(t) by p. That is, when the phase of S(t) is θₖ, the phase of the signal S*(t) becomes ψₖ=θₖ+μ.

FIG. 9B is a QPSK constellation diagram when the signal S(t) is on an axis, and FIG. 9C is a QPSK constellation diagram of a signal S*(t) obtained by rotating the signal S(t) illustrated in FIG. 9B by μ=π/4.

By using equation 6, the signal S*(t) is expressed as equation 17 below:

S*(r)=A cos(ω_{c}t+θᵢ+μ)=A(ω_{c}t+ψᵢ) (17)

In the case of MPSK modulation, the phase information ψᵢ=θᵢ+μ can be expressed as equation 18 below according to M symbols:

$${ψ}_{i} = {θ}_{i} + μ = \frac{( 2 i - 1 ) π}{M} + μ ; \\ i = 1 , 2 , 3 , … , M \qquad ( 18 )$$

The φ_{Q} and φ_{I} values of the signal S*(t) are obtained by adding the phase shift p to the phase values φ_{Q} and φ_{Q} of the present invention obtained from the assumption described above. The result is illustrated in table 3, which corresponds to table 2 of the constellation diagram based on the assumption. However, table 3 assumes that φ_{Q} and φ_{I} are in the range of [0,2π].

TABLE 3

| Classification | Ψ Range (Ψ = θ + μ) | φ_{I} | φ_{Q} |
|---|---|---|---|
| Ψ Quadrant I | 0 < θ ≦ π/2 | Ψ | Ψ |
| Ψ Quadrant II | π/2 < θ ≦ π | Ψ + π | Ψ |
| Ψ Quadrant III | π < θ ≦ 3π/2 | Ψ − π | Ψ − π |
| Ψ Quadrant IV | 3π/2 < θ ≦ 2π | Ψ | Ψ − π |

It should be noted that in order to directly use phase information LP; on the reception side, as in the transmission side, a signal constellation diagram in which p is added to the initial phase should be used. That is, a constellation diagram based on I channel data and Q channel data on the transmission side and the reception side for an amplitude increasing effect has a signal arranged in a quadrant as a result of rotation by adding p to the initial phase, and all signals are symmetric about the axes.

So far, the principle of the present invention of increasing amplitude by constructive interference effect has been explained. An I/Q modulator according to an embodiment of the present invention will now be explained.

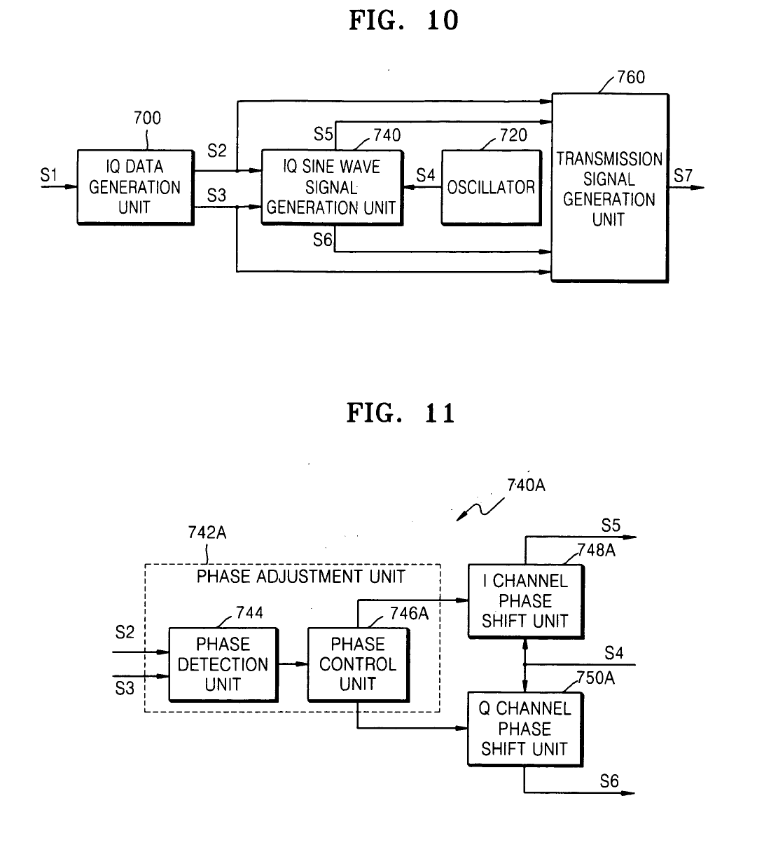

FIG. 10 is a block diagram of an I/Q modulation apparatus according to an embodiment of the present invention, which is composed of an I/Q data generation unit 700, an oscillator 720, an IQ sine wave signal generation unit 740, and a transmission signal generation unit 760.

The I/Q data generation unit 700 transforms a binary stream (S1) according to an I/Q modulation technique, thereby generating I channel data (S2) and Q channel data (S3). Here, examples of the I/Q modulation technique are quadrature phase shifting keying (QPSK), offset quadrature phase shift keying (OQPSK), π/4-differential quadrature phase shifting keying (DQPSK), Walsh QPSK, hybrid QPSK, M-ary phase shift keying (MPSK), amplitude phase shift keying (APSK), hierarchical PSK, and M-QAM. However, the I/Q modulation technique is not limited to these.

The oscillator 720 generates a sine wave signal (S4) as described above.

The IQ sine wave signal generation unit 740 adjusts the phase of the sine wave signal (S4) based on the I and Q channel data (S2, S3), thereby generating an I channel sine wave signal (S5) and a Q channel sine wave signal (S6) that satisfy a predetermined condition. The predetermined condition is that a signal obtained by combining a first signal, which is obtained by applying the I channel data (S2) to the I channel sine wave signal (S5), and a second signal, which is obtained by applying the Q channel data (S3) to the Q channel sine wave signal (S6), has a phase in a signal constellation diagram corresponding to the I and Q channel data (S2, S3).

In an embodiment, the IQ sine wave signal generation unit 740 may generate the I channel sine wave signal (S5) and the Q channel sine wave signal (S6) satisfying the condition that the absolute value of the phase difference between the first signal and the second signal is 2n IT (here, n is an integer equal to or greater than 0). Also, in another embodiment, the IQ sine wave signal generation unit 740 may generate the I channel sine wave signal (S5) and the Q channel sine wave signal (S6) satisfying the condition that the absolute value of the phase difference between the first signal and the second signal belongs to (2n π, 2 nπ+π/2) (here, n is an integer equal to or greater than 0).

The transmission signal generation unit 760 respectively applies the I channel data (S2) and the Q channel data (S3) to the I channel sine wave signal (S5) and the Q channel sine wave signal (S6), thereby generating a transmission signal (S7) corresponding to the I and Q channel data.

FIG. 11 is a block diagram of the IQ sine wave signal generation unit 740A illustrated in FIG. 10, which is composed of a phase adjustment unit 742A, an I channel phase shift unit 748A, and a Q channel phase shift unit 750A.

The I channel phase shift unit 748A shifts the phase of the sine wave signal (S4) according to control by the phase adjustment unit 742A, thereby generating the I channel sine wave signal (S5).

The Q channel phase shift unit 750A shifts the phase of the sine wave signal (S4) according to control by the phase adjustment unit 742A, thereby generating the Q channel sine wave signal (S6).

The phase adjustment unit 740A adjusts the phase shift of the I channel phase shift unit 748A and the Q channel phase shift unit 750A based on the I channel data (S2) and the Q channel data (S3).

Referring to FIG. 11, the phase adjustment unit 740A is composed of a phase detection unit 744A and a phase control unit 746A.

The phase detection unit 744A detects the phases in the signal constellation diagram corresponding to the I and Q channel data (S2, S3). Here, an example of the method of detecting phase is may be a method using equation 20, which will be explained later. However, it can be easily understood by a person skilled in the art that the method of detecting phase is not limited to the method using equation 20.

Based on the detected phases, the phase control unit 746A adjusts the phase shifts of the I channel phase shift unit 748A and the Q channel phase shift unit 750A. In the present specification, 4 examples of adjustment methods of the phase control unit 746A will now be explained.

In the first adjustment method, if the I channel data (S2) is equal to or less than 0, the phase control unit 746A determines the phase shift of the I channel phase shift unit 748A according to a phase obtained by adding 2 mπ+π (here, m is an integer) to the detected phase. If the I channel data (S2) is greater than 0, the phase control unit 746A determines the phase shift of the I channel phase shift unit 748A according to the detected phase. If the Q channel data (S3) is equal to or less than 0, the phase control unit 746A determines the phase shift of the Q channel phase shift unit 750A according to a phase obtained by adding 2 nπ+π (here, n is an integer) to the detected phase. If the Q channel data (S3) is greater than 0, the phase control unit 746A determines the phase shift of the Q channel phase shift unit 750A according to the detected phase. Then, the phase shift of the I channel phase shift unit 748A and the phase shift of the Q channel phase shift unit 750A are adjusted according to the determined phase shifts.

In the second adjustment method, if the I channel data (S2) is equal to or less than 0, the phase control unit 746A determines the phase shift of the I channel phase shift unit 748A according to a phase obtained by adding 2 mπ+π (here, m is an integer) to the detected phase. If the I channel data (S2) is greater than 0, the phase control unit 746A determines the phase shift of the I channel phase shift unit 748A according to the detected phase. If the Q channel data (S3) is less than 0, the phase control unit 746A determines the phase shift of the Q channel phase shift unit 750A according to a phase obtained by adding 2 nπ+π (here, n is an integer) to the detected phase. If the Q channel data (S3) is equal to or greater than 0, the phase control unit 746A determines the phase shift of the Q channel phase shift unit 750A according to the detected phase. Then, the phase shift of the I channel phase shift unit 748A and the phase shift of the Q channel phase shift unit 750A are adjusted according to the determined phase shifts.

In the third adjustment method, if the I channel data (S2) is less than 0, the phase control unit 746A determines the phase shift of the I channel phase shift unit 748A according to a phase obtained by adding 2mπ+π (here, m is an integer) to the detected phase. If the I channel data (S2) is equal to or greater than 0, the phase control unit 746A determines the phase shift of the I channel phase shift unit 748A according to the detected phase. If the Q channel data (S3) is equal to or less than 0, the phase control unit 746A determines the phase shift of the Q channel phase shift unit 750A according to a phase obtained by adding 2 nπ+π (here, n is an integer) to the detected phase. If the Q channel data (S3) is greater than 0, the phase control unit 746A determines the phase shift of the Q channel phase shift unit 750A according to the detected phase. Then, the phase shift of the I channel phase shift unit 748A and the phase shift of the Q channel phase shift unit 750A are adjusted according to the determined phase shifts.

In the fourth adjustment method, if the I channel data (S2) is less than 0, the phase control unit 746A determines the phase shift of the I channel phase shift unit 748A according to a phase obtained by adding 2 mπ+π (here, m is an integer) to the detected phase. If the I channel data (S2) is equal to or greater than 0, the phase control unit 746A determines the phase shift of the I channel phase shift unit 748A according to the detected phase. If the Q channel data (S3) is less than 0, the phase control unit 746A determines the phase shift of the Q channel phase shift unit 750A according to a phase obtained by adding 2 nπ+π (here, n is an integer) to the detected phase. If the Q channel data (S3) is equal to or greater than 0, the phase control unit 746A determines the phase shift of the Q channel phase shift unit 750A according to the detected phase. Then, the phase shift of the I channel phase shift unit 748A and the phase shift of the Q channel phase shift unit 750A are adjusted according to the determined phase shifts.

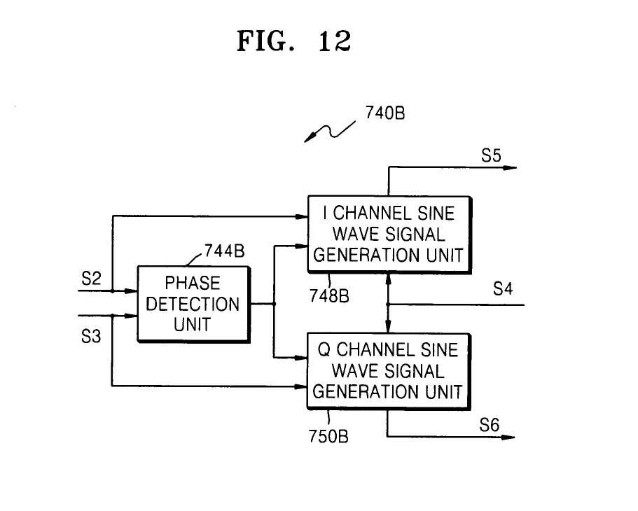

FIG. 12 is a block diagram of the IQ sine wave signal generation unit 740B illustrated in FIG. 10, which is composed of a phase detection unit 744B, an I channel sine wave signal generation unit 748A and a Q channel sine wave signal generation unit 750B.

Like the phase detection unit 744A of FIG. 11, the phase detection unit 744B detects a phase in a signal constellation diagram corresponding to the I and Q channel data (S2, S3).

The I channel sine wave signal generation unit 748B shifts the phase of the sine wave signal (S4) based on the detected phase, thereby generating an I channel sine wave signal (S5). In the present specification, two examples of a method of generating an I channel sine wave signal will now be explained.

In the first method, if the I channel data (S2) is equal to or less than 0, the I channel sine wave signal generation unit 748B shifts the phase of the sine wave signal (S4) such that the phase of the I channel sine wave signal (S5) becomes a phase obtained by adding 2 mπ+π (here, m is an integer) to the detected phase. If the I channel data (S2) is greater than 0, the I channel sine wave signal generation unit 748B shifts the phase of the sine wave signal (S4) such that the phase of the I channel sine wave signal (S5) becomes the detected phase. In this way, the I channel sine wave signal (S5) is generated.

In the second method, if the I channel data (S2) is less than 0, the I channel sine wave signal generation unit 748B shifts the phase of the sine wave signal (S4) such that the phase of the I channel sine wave signal (S5) becomes a phase obtained by adding 2 mπ+π (here, m is an integer) to the detected phase. If the I channel data (S2) is equal to or greater than 0, the I channel sine wave signal generation unit 748B shifts the phase of the sine wave signal (S4) such that the phase of the I channel sine wave signal (S5) becomes the detected phase. In this way, the I channel sine wave signal (S5) is generated.

Likewise, the Q channel sine wave signal generation unit 7506 shifts the phase of the sine wave signal (S4) based on the detected phase, thereby generating a Q channel sine wave signal (S6). In the present specification, two examples of a method of generating a Q channel sine wave signal will now be explained.

In the first method, if the Q channel data (S3) is equal to or less than 0, the Q channel sine wave signal generation unit 750B shifts the phase of the sine wave signal (S4) such that the phase of the Q channel sine wave signal (S6) becomes a phase obtained by adding 2 mπ+π (here, m is an integer) to the detected phase. If the Q channel data (S3) is greater than 0, the Q channel sine wave signal generation unit 750B shifts the phase of the sine wave signal (S4) such that the phase of the Q channel sine wave signal (S6) becomes the detected phase. In this way, the Q channel sine wave signal (S6) is generated.

In the second method, if the Q channel data (S3) is less than 0, the Q channel sine wave signal generation unit 750B shifts the phase of the sine wave signal (S4) such that the phase of the Q channel sine wave signal (S6) becomes a phase obtained by adding 2 mπ+π (here, m is an integer) to the detected phase. If the Q channel data (S3) is equal to or greater than 0, the Q channel sine wave signal generation unit 750B shifts the phase of the sine wave signal (S4) such that the phase of the Q channel sine wave signal (S6) becomes the detected phase. In this way, the Q channel sine wave signal (S6) is generated.

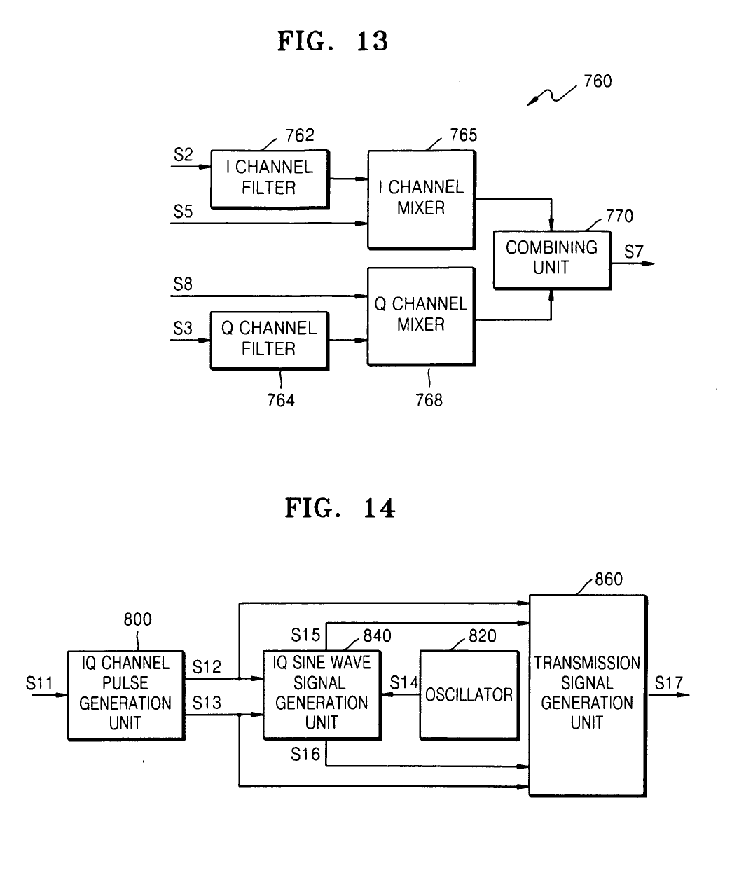

FIG. 13 is a block diagram of the transmission signal generation unit 760 illustrated in FIG. 10 according to an embodiment of the present invention, which is composed of an I channel filter 762, a Q channel filter 764, an I channel mixer 766, a Q channel mixer 768, and a combining unit 770.

The I channel filter 762 converts the I channel data (S2) to a predetermined pulse.

The Q channel filter 764 converts the Q channel data (S3) to a predetermined pulse.

The I channel mixer 766 mixes the output of the I channel filter 762 and the I channel sine wave signal (S5).

The Q channel mixer 768 mixes the output of the Q channel filter 764 and the Q channel sine wave signal (S6).

The combining unit 770 combines the output of the I channel mixer 766 and the output of the Q channel mixer 768, thereby generating a transmission signal (S7).

Meanwhile, the I channel filter 762 and the Q channel filter 764 are used to reduce interference with neighboring bands, and to improve the performance of wave detection on the reception side, Accordingly, in another embodiment, the I channel filter 762 and the Q channel filter 764 may be omitted, and the I channel mixer 766 may apply the I channel data (S2) directly to the I channel sine wave signal (S5) and the Q channel mixer 768 may apply the Q channel data (S3) directly to the Q channel sine wave signal (S6). This embodiment can be easily understood by a person skilled in the art.

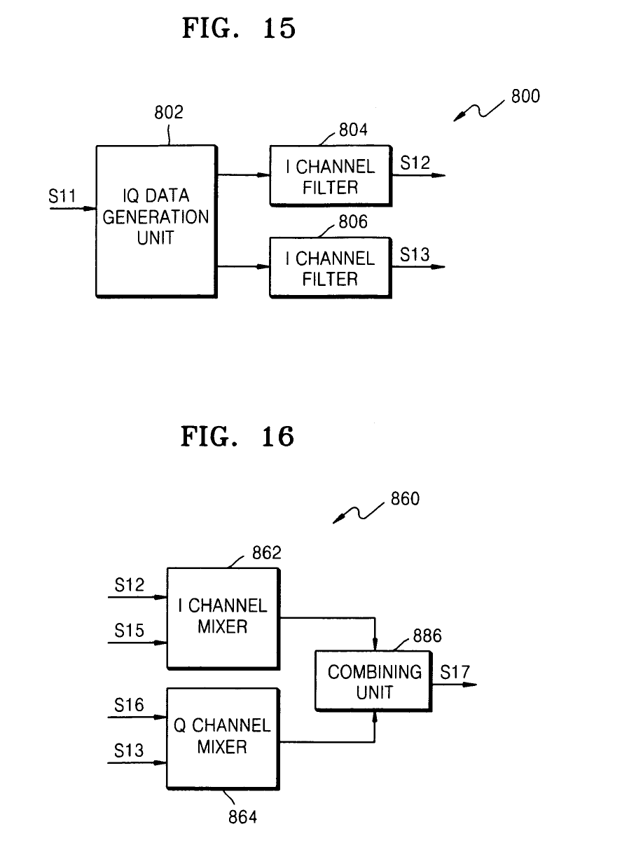

FIG. 14 is a block diagram of an I/Q modulation apparatus according to another embodiment of the present invention, which is composed of an I/Q channel pulse generation unit 800, an oscillator 820, an IQ sine wave signal generation unit 840, and a transmission signal generation unit 860. Unlike the embodiment of FIG. 10 which detects the necessary phase of the transmission signal from I channel data and Q channel data, in the embodiment of FIG. 14, the necessary phase of the transmission signal is detected from an I channel pulse and a Q channel pulse.

The oscillator 820 generates a sine wave signal (S14).

The I/Q channel pulse generation unit 800 generates an I channel pulse (S12) and a Q channel pulse (S13) corresponding to an input binary stream (S11).

The IQ sine wave signal generation unit 840 adjusts the phase of the sine wave signal (S14) based on the generated I and Q channel pulses (S12, S13), thereby generating an I channel sine wave signal (S15) and a Q channel sine wave signal (S16) that satisfy a predetermined condition. The predetermined condition is that a signal obtained by combining a first signal, which is obtained by applying the I channel pulse (S12) to the I channel sine wave signal (S15), and a second signal, which is obtained by applying the Q channel pulse (S13) to the Q channel sine wave signal (S16), has a phase in a signal constellation diagram corresponding to the I and Q channel pulses (S12, S13).

In an embodiment, the IQ sine wave signal generation unit 840 may generate the I channel sine wave signal (S15) and the Q channel sine wave signal (S16) satisfying the condition that the absolute value of the phase difference between the first signal and the second signal is 2n π (here, n is an integer equal to or greater than 0). Also, in another embodiment, the IQ sine wave signal generation unit 840 may generate the I channel sine wave signal (S15) and the Q channel sine wave signal (S16) satisfying the condition that the absolute value of the phase difference between the first signal and the second signal belongs to (2n π, 2 nπ+π/2) (here, n is an integer equal to or greater than 0).

The transmission signal generation unit 860 applies the I channel pulse (S12) and the Q channel pulse (S13) respectively to the I channel sine wave signal (S15) and the Q channel sine wave signal (S16), thereby generating a transmission signal (S17) corresponding to the I and Q channel pulses (S12, S13).

FIG. 15 is a block diagram of the I/Q channel pulse generation unit 800 illustrated in FIG. 14 according to an embodiment of the present invention, which is composed of an I/Q data generation unit 802, an I channel filter 804, and a Q channel filter 806.

The IQ data generation unit 802 transforms a binary stream (S1) according to an I/Q modulation technique, thereby generating I channel data and Q channel data. Here, examples of the I/Q modulation technique are QPSK, OQPSK, π/4-DQPSK, Walsh QPSK, hybrid QPSK, MPSK, APSK, hierarchical PSK, and M-QAM. However, the I/Q modulation technique is not limited to these.

The I channel filter 804 converts the generated I channel data into an I channel pulse (S12). Likewise, the Q channel filter 806 converts the generated Q channel data into a Q channel pulse (S13). Here, the filter in the I channel filter 804 and the Q channel filter 806 may be a raised cosine filter. In this case, the peak values of the I channel pulse (S12) and the Q channel filter (S13) have values corresponding respectively to the I channel data and the Q channel data.

FIG. 16 is a block diagram of a transmission signal generation unit illustrated in FIG. 14 according to an embodiment of the present invention, which is composed of an I channel mixer 862, a Q channel mixer 864, and a combining unit 866.

The I channel mixer 862 mixes the I channel pulse (S12) and the I channel sine wave signal (S15).

Likewise, the Q channel mixer 864 mixes the Q channel pulse (S13) and the Q channel sine wave signal (S16).

The combining unit 866 combines the output of the I channel mixer 862 and the output of the Q channel mixer 864, thereby generating a transmission signal.

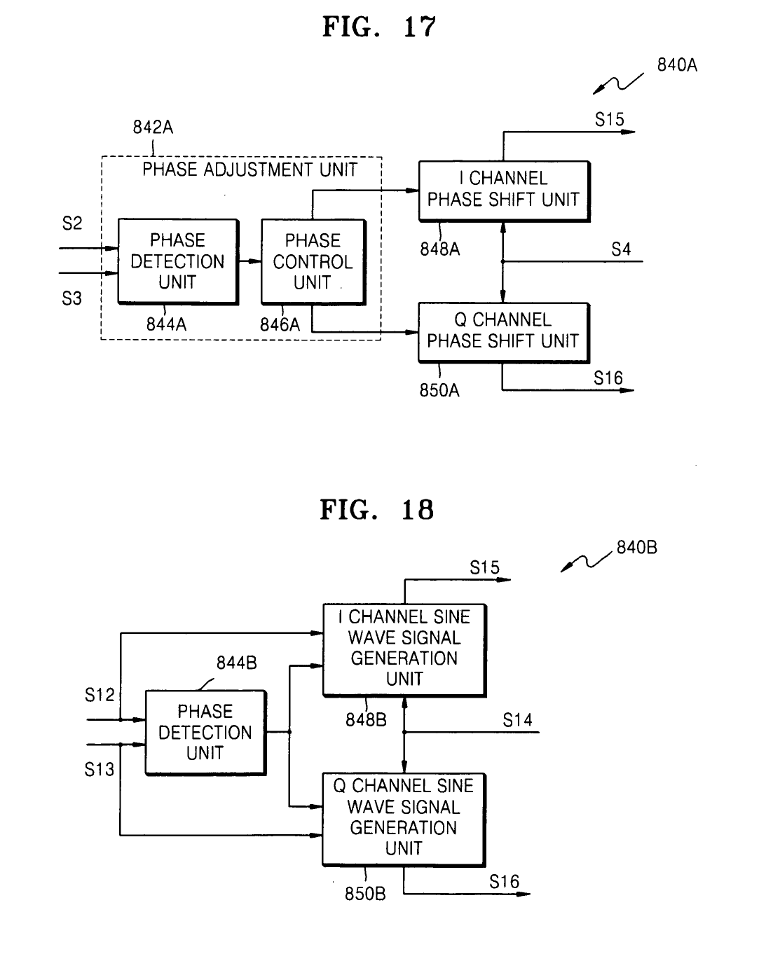

FIG. 17 is a block diagram of the IQ sine wave signal generation unit 840A of FIG. 14, which is composed of a phase adjustment unit 842A, an I channel phase shift unit 848A, and a Q channel phase shift unit 850A.

The I channel phase shift unit 848A shifts the phase of the sine wave signal (S14) according to control of the phase adjustment unit 842A, thereby generating the I channel sine wave signal (S15). Likewise, the Q channel phase unit 850A shifts the phase of the sine wave signal (S14) according to control of the phase adjustment unit 842A, thereby generating the Q channel sine wave signal (S16).

Based on the I and Q channel pulses (S12, S13), the phase adjustment unit 842A adjusts the amounts of phase shift in the I channel phase shift unit 848A and th3 Q channel phase shift unit 850A.

More specifically, referring to FIG. 17, the phase adjustment unit 842A is composed of a phase detection unit 844A detecting phases in a signal constellation diagram corresponding to the I and Q channel pulses (S12, S13), and a phase control unit 846A adjusting the phase shifts of the I channel phase shift unit 848A and the Q channel phase shift unit 850A based on the detected phases.

FIG. 18 is a block diagram of the IQ sine wave signal generation unit 840A of FIG. 14 according to another embodiment of the present invention, which is composed of a phase detection unit 844B, an I channel sine wave signal generation unit 848A and a Q channel sine wave signal generation unit 850B.

The phase detection unit 844B detects a phase in a signal constellation diagram corresponding to the I and Q channel pulses (S12, S13).

The I channel sine wave signal generation unit 848B shifts the phase of the sine wave signal (S14) based on the detected phase, thereby generating an I channel sine wave signal (S15). In the present specification, two examples of a method of generating an I channel sine wave signal will now be explained.

In the first method, if the peak value of the I channel pulse (S12) is equal to or less than 0, the I channel sine wave signal generation unit 848B shifts the phase of the sine wave signal (S14) such that the phase of the I channel sine wave signal (S15) becomes a phase obtained by adding 2 mπ+π (here, m is an integer) to the detected phase. If the peak value of the I channel pulse (S12) is greater than 0, the I channel sine wave signal generation unit 848B shifts the phase of the sine wave signal (S14) such that the phase of the I channel sine wave signal (S15) becomes the detected phase. In this way, the I channel sine wave signal (S15) is generated.

In the second method, if the peak value of the I channel pulse (S12) is less than 0, the I channel sine wave signal generation unit 848B shifts the phase of the sine wave signal (S14) such that the phase of the I channel sine wave signal (S15) becomes a phase obtained by adding 2mπ+π (here, m is an integer) to the detected phase. If the peak value of the I channel pulse (S12) is equal to or greater than 0, the I channel sine wave signal generation unit 848B shifts the phase of the sine wave signal (S14) such that the phase of the I channel sine wave signal (S15) becomes the detected phase. In this way, the I channel sine wave signal (S15) is generated.

Likewise, the Q channel sine wave signal generation unit 850B shifts the phase of the sine wave signal (S14) based on the detected phase, thereby generating a Q channel sine wave signal (S16). In the present specification, two examples of a method of generating a Q channel sine wave signal will now be explained.

In the first method, if the peak value of the Q channel pulse (S13) is equal to or less than 0, the Q channel sine wave signal generation unit 850B shifts the phase of the sine wave signal (S14) such that the phase of the Q channel sine wave signal (S16) becomes a phase obtained by adding 2 mπ+π (here, m is an integer) to the detected phase. If the peak value of the Q channel pulse (S13) is greater than 0, the Q channel sine wave signal generation unit 850B shifts the phase of the sine wave signal (S14) such that the phase of the Q channel sine wave signal (S16) becomes the detected phase. In this way, the Q channel sine wave signal (S16) is generated.

In the second method, if the peak value of the Q channel pulse (S13) is less than 0, the Q channel sine wave signal generation unit 850B shifts the phase of the sine wave signal (S14) such that the phase of the Q channel sine wave signal (S16) becomes a phase obtained by adding 2 mπ+π (here, m is an integer) to the detected phase. If the peak value of the Q channel pulse (S13) is equal to or greater than 0, the Q channel sine wave signal generation unit 850B shifts the phase of the sine wave signal (S14) such that the phase of the Q channel sine wave signal (S16) becomes the detected phase. In this way, the Q channel sine wave signal (S6) is generated.

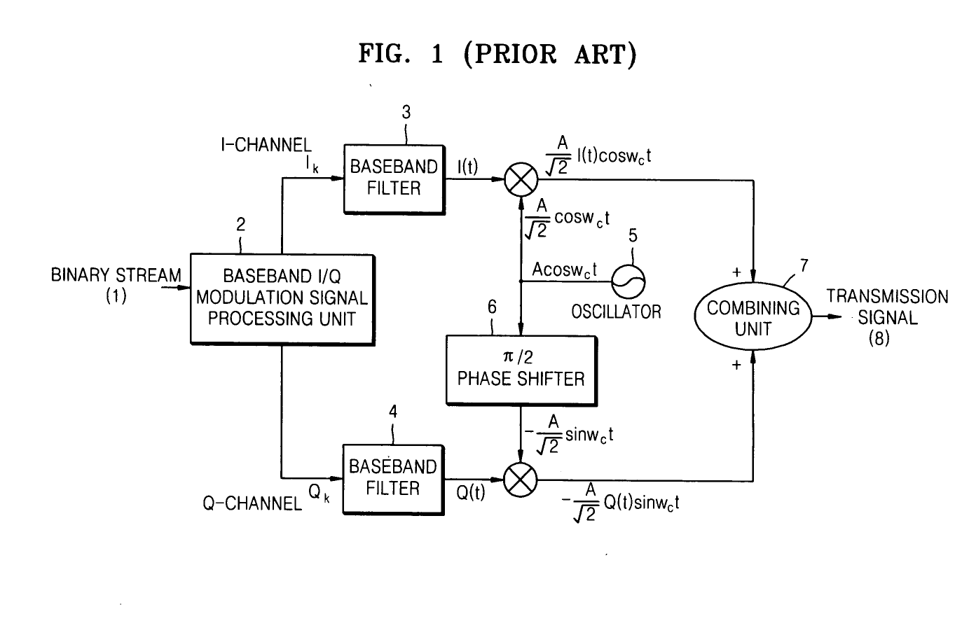

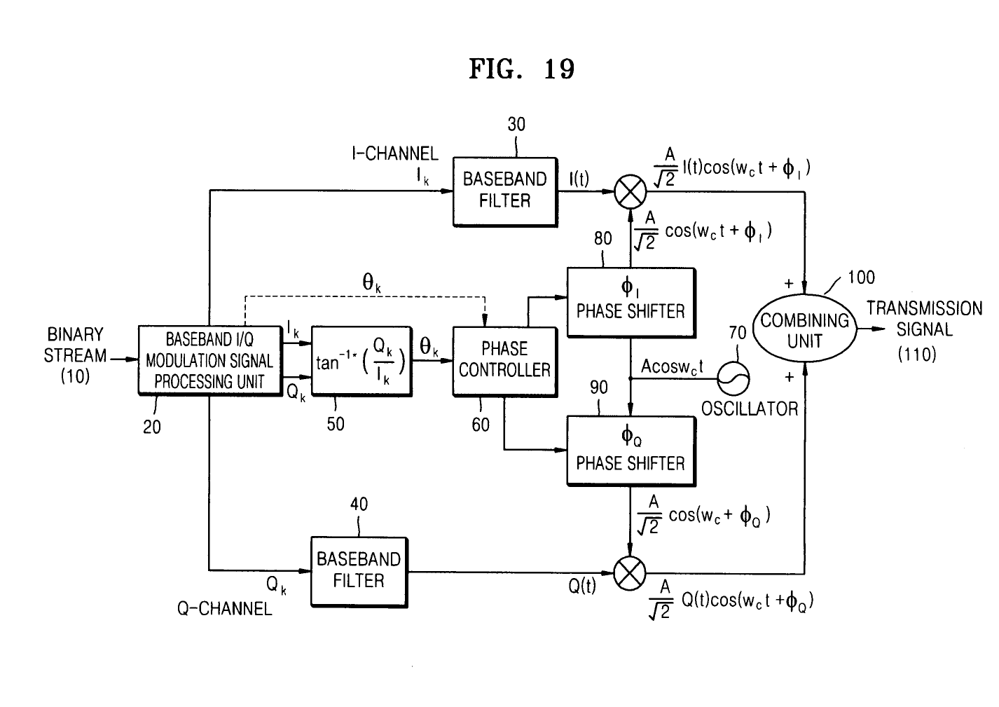

FIG. 19 illustrates the concept of an I/Q modulation apparatus according to an embodiment of the present invention. FIG. 19 is a block diagram of the I/Q modulation apparatus according to current embodiment, and can be compared with FIG. 1 illustrating the conventional I/Q modulation apparatus.

Referring to FIG. 19, the I/Q modulation apparatus according to the current embodiment is composed of a baseband I/Q modulation signal processing unit 20, baseband filters 30 and 40, a cotangent function unit 50, a phase controller 60, an oscillator 70, a φ_{I} phase shifter 80, a φ_{Q} phase shifter 90, and a combining unit 100.

The baseband I/Q modulation signal processing unit 20 determines a symbol transmitted at each time interval Tₛ with respect to an input binary stream 10, and generates 2 signals Iₖ and Qₖ, in the same way as the conventional method.

The originality of the present invention is that a transmission signal is generated by adjusting φ_{I} and φ_{Q}, which are the phase shifts of the φ_{I} phase shifter 80 and the φ_{Q} phase shifter 90, with respect to the two input signals Iₖ and Qₖ.

As a specific structure for this, referring to FIG. 19, the phase controller 60 controls φ_{Q} and φ_{I} of the φ_{I} phase shifter 80 and the φ_{Q} phase shifter 90 according to a phase θₖ obtained with respect to Iₖ and Qₖ values. One method of obtaining the phase θₖ is to use the cotangent function unit 50 performing the operation defined by equation 20, which will be explained later. That is, referring to FIG. 19, the phase controller 60 adjusts φ_{I} of the φ_{I} phase shifter 80 and φ_{Q} of the φ_{Q} phase shifter 90 according to the quadrant to which the input phase θₖ belongs, as defined in table 2, thereby increasing the amplitude of a transmission signal 110.

The baseband I/Q modulation signal processing unit of the current embodiment inputs the two signals Iₖ and Qₖ that are mapped according to a variety of I/Q modulation methods, respectively to the baseband filter 30 in an I channel and the baseband filter 40 in a Q channel, and also inputs the two signals Iₖ and Qₖ to the cotangent function unit 50. The cotangent function unit 50 calculates the phase θₖ=tan^{-1*}(Qₖ/Iₖ) by using the function defined as equation 20, and inputs the result to the phase controller 60. Here, the calculation process by the cotangent function unit 50 may be omitted in an actual communication system, by performing the calculation in the baseband I/Q modulation signal processing unit 20 in advance. If the baseband I/Q modulation signal processing unit 20 calculates the phase φₖ in a table for mapping the two signals Iₖ and Qₖ in advance, the baseband I/O modulation signal processing unit 20 may directly input the quadrant position information of the phase θₖ to the phase controller 60 without calculation by the cotangent function unit 50. According to the input quadrant position information of the phase θₖ, the phase controller 60 determines two phase values φ_{I} and φ_{Q} suggested in table 2, as φ_{I} of the φ_{I} phase shifter 80 and φ_{Q} of the φ_{Q} phase shifter 90.

The oscillator 70 generates a signal Acosω_{c}t, and then inputs a signal (A/\sqrt{2})cosω_{c}t to the φ_{I} phase shifter 80 and the φ_{Q} phase shifter 90. The φ_{I} phase shifter 80 generates a signal (A/\sqrt{2})cos(ω_{c}t+φᵢ) by using the phase φ_{I} input from the phase controller 60. The signal (A/\sqrt{2})cos(ω_{c}t+φᵢ) is multiplied by an output signal I(t) of the I channel baseband filter 30, thereby generating a signal (A/\sqrt{2})I(t)cos(ω_{c}t+φᵢ). Then, the signal (A/\sqrt{2})I(t)cos(ω_{c}t+φᵢ) is input to the combining unit 100. The φ_{Q} phase shifter 90 generates a signal (A\sqrt{2})cos(ω_{c}t+φ_{Q}) by using the phase φ_{Q} input from the phase controller 60. The signal (A/\sqrt{2})cos(ω_{c}t+φ_{Q}) is multiplied by a signal Q(t) passing through the Q channel baseband filter 40, thereby generating a signal (A/\sqrt{2})Q(t)cos(ω_{c}t+φ_{Q}). Then, the signal (A/\sqrt{2})I(t)cos(ω_{c}t+φᵢ) is input to the combining unit 100. The combining unit 100 combines the two signals (A/\sqrt{2})/(t)cos(ω_{c}t+φᵢ) and (A/\sqrt{2})Q(t)cos(ω_{c}t+φ_{Q}), thereby generating a transmission signal Sⁿ(t) 110 of the I/Q modulation apparatus to which the present invention is applied, as equation 19 below:

$${S}^{n} ( t ) = \frac{A}{\sqrt{2}} I ( t ) cos ( {ω}_{c} t + {φ}_{l} ) + \frac{A}{\sqrt{2}} Q ( t ) cos ( {ω}_{c} t + {φ}_{Q} ) \qquad ( 19 )$$

After that, the transmission signal transmitted according to the current embodiment can be demodulated by a conventional I/Q demodulator.

The operations performed by the cotangent function unit 50 will now be explained. The range of a phase θ of an arbitrary signal S(t) expressed as coordinates (I,Q) in a rectangular coordinate system is [0,2π]. However, since the range of tan⁻¹(Q/I) is generally limited to [−π/2,π2], a definition of a new cotangent function tan^{-1*}(Q/I) is necessary in the present invention.

The new cotangent function tan^{-1*}(Q/I) used in the present invention is expressed as equation 20 below:

$${tan}^{- 1 *} ( \frac{Q}{I} ) {=}^{Δ} \frac{π}{2} [ 1 - sgn ( I ) ] + sgn ( I ) {tan}^{- 1} ( \frac{Q}{\vert I \vert} ) + \frac{π}{2} [ 1 - sgn ( I ) sgn ( IQ ) ] [ 1 + sgn ( I ) sgn ( IQ ) ] ; \\ - ∞ < I < ∞ and - ∞ < Q < ∞ ( excluding when I = 0 ) \qquad ( 20 )$$

Here, the function sgn( ) is defined as equation 21 below:

$$sgn ( u ) = \{ \begin{matrix}1 , & u \geq 0 \\ - 1 , & u < 0\end{matrix} \qquad ( 21 )$$

In order to verify the validity of tan^{-1*}(Q/I) suggested in the present invention, an example of 8-PSK will now be explained. Table 4 illustrates the result of obtaining tan^{-1*}(Q/I) by using I channel values and Q channel values of 8-PSK, and errors with respect to the original symbol phases of the 8-PSK. The errors are very small, confirming the validity of tan^{-1*}(Q/I) suggested in the present invention.

TABLE 4

| θi = (2i − 1)π/M | Iᵢ = cosθᵢ | Qᵢ = sinθᵢ |
|---|---|---|
| π/8 | 9.2388e−001 | 3.8268e−001 |
| 3π/8 | 3.8268e−001 | 9.2388e−001 |
| 5π/8 | −3.8268e−001 | 9.2388e−001 |
| 7π/8 | −9.2388e−001 | 3.8268e−001 |
| 9π/8 | −9.2388e−001 | −3.8268e−001 |
| 11π/8 | −3.8268e−001 | −9.2388e−001 |
| 13π/8 | 3.8268e−001 | −9.2388e−001 |
| 15π/8 | 9.2388e−001 | −3.8268e−001 |

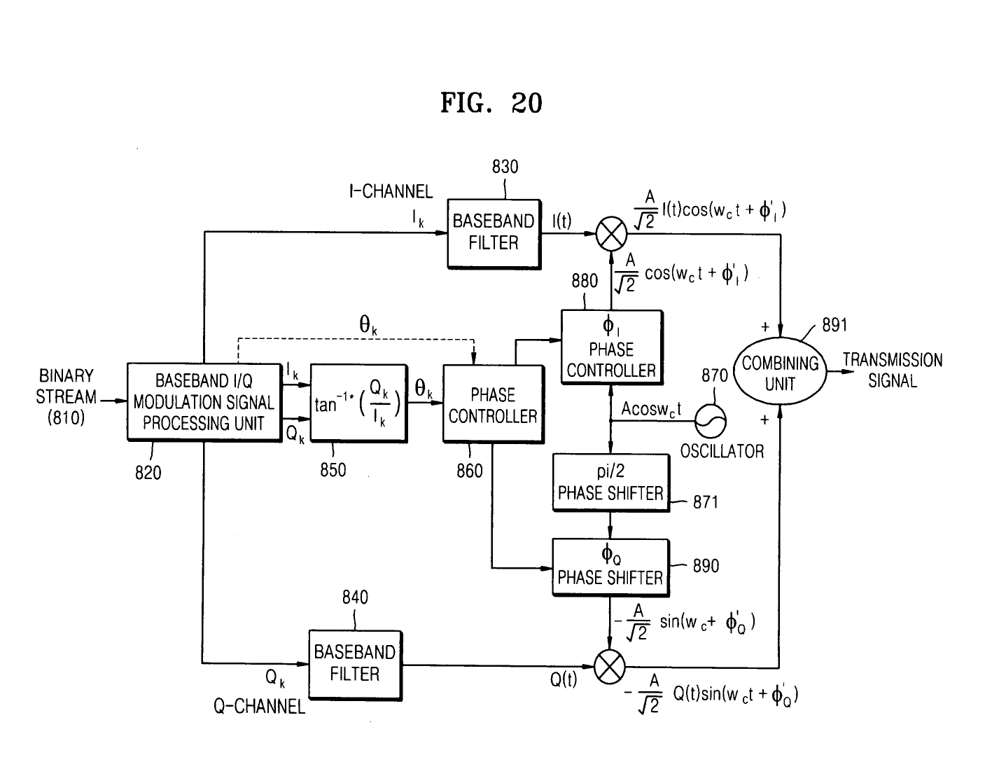

FIG. 20 illustrates the concept of an I/Q modulation apparatus according to another embodiment of the present invention. FIG. 20 is a block diagram of the I/Q modulation apparatus according to current embodiment, and can be compared with FIG. 1 illustrating the conventional I/Q modulation apparatus.

Referring to FIG. 20, the I/Q modulation apparatus according to the current embodiment is composed of a baseband I/Q modulation signal processing unit 820, baseband filters 830 and 840, a cotangent function unit 850, a phase controller 60, a phase controller 860, an oscillator 870, a π/2 phase shifter 871, a φ′_{I} phase shifter 880, a φ′_{Q} phase shifter 890, and a combining unit 891.

When compared with FIG. 19, the modulation apparatus of FIG. 20 further includes the π/2 phase shifter 871, and when compared with FIG. 1, further includes the φ′_{I} phase shifter 880 and the φ′_{Q} phase shifter 890. Accordingly, since the elements of the I/Q modulation apparatus of FIG. 20 are the same as the corresponding elements in FIGS. 1 and 19, explained above, an explanation of FIG. 20 will be omitted here.

A process of constructive interference according to the embodiment of the present invention of FIG. 20 and the process of generating a transmission signal according to the conventional modulation method will now be explained in an intuitive method.

φ′_{I} and φ′_{Q} illustrated in FIG. 20 can be expressed as equations 22 and 23 expressed with φ_{I} and φ_{Q} described above with reference to table 2 and others:

φ_{I}=φ′_{I} (22)

φ_{Q}=π/2+φ′_{Q} (23)

According to the example illustrated in FIG. 20, phase shift values to be adjusted are φ′_{I} and φ′_{Q}, and specific values are illustrated in table 5 which will be explained later. Hereinafter, the transmission signal according to the embodiment illustrated in FIG. 11 will be expressed as Sⁿ(t)′.

An amplitude increasing effect occurring when the present invention is applied to an MPSK modulator will now be explained. In general, in the MPSK modulation, phase information is transmitted as equation 24 below according to M symbols:

$${θ}_{i} = \frac{( 2 i - 1 ) π}{M} ; i = 1 , 2 , 3 , … M \qquad ( 24 )$$

An MPSK symbol transmitted at a k-th symbol time [kTₛ, (k+1)Tₛ] by the baseband I/Q signal processing unit 820 is expressed by Iₖ and Qₖ values in a rectangular coordinate system corresponding to phase θₖ at each symbol time interval Tₛ, and the Iₖ and Qₖ values are respectively expressed as equations 25 and 26, below:

Iₖ=\sqrt{2}cos θₖ (25)

Qₖ=\sqrt{2}sin φₖ (26)

Here, phase θₖ is the phase of a k-th transmission symbol, and is one of the symbol phases θᵢ defined as equation 24.

Equations 25 and 26 are respectively applied to equations 1 and 2 for substitution, and then, by using equation 3, the signal S° MPSK(t) according to the conventional MPSK I/Q modulator can be expressed as equation 27 below:

S_{MPSK}^{( )}(t)=A cos θₖ cos ω_{c}t−A sin θₖ sin ω_{c}t=A cos(ω_{c}t+θₖ) (27)

By using the characteristics of a trigonometric function, equation 27 can be expressed as equation 28 below:

S_{MPSK}^{( )}(t)=A cos θₖ cos ω_{c}t+A sinθₖ sin ω_{c}t+π/2)=A cos(ω_{c}t+θₖ) (28)

The phase of the sine wave signal of the first term of equation 28 is different from the phase of the sine wave signal of the second term. In the present invention, these phases are made to be the same, such that these phases are made to be equal to the phase θₖ of a final transmission signal Acos(ω_{c}t+θₖ). In this way, the amplitude of the signal is made to be greater than the amplitude A of the transmission signal according to the conventional modulation method, while transmitting the original message information.

An amplitude increasing effect by adjusting phases φ_{I} and φ_{Q} when θₖ is positioned in each quadrant will now be explained in a quantitative way.

First, a case where θₖ is positioned in the first quadrant will be explained. Here, since cosθₖ=|cosθₖ|, and sinθₖ=|sinθₖ|, equation 28 can be expressed as equation 29 below:

S_{MPSK}^{( )}(t)=A|cos θₖ|cos ω_{c}t−A|sin θₖ|sin θₖ|cos(ω_{c}t+π/2)=A cos(ω_{c}t+θₖ) (29)

According to the principle of the present invention, when the phases of two sine waves are adjusted to be the same, if the phase of a transmission signal formed of the sum of the two sine waves is adjusted to be the same as the phase θₖ of the message signal, the transmission signal according to the embodiment of FIG. 20 can be expressed as equation 30:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 30 )$$

When equation 29 is compared with equation 30, the modulation method of the present invention provides the effect of transmitting the phase θₖ of the existing message signal by using a carrier wave whose amplitude is increased by |cosθₖ|+|sin φₖ| compared to the conventional carrier wave. Here, \sqrt{(|cos θₖ|+|sin θₖ|)²}=\sqrt{1+|sin 2θₖ}.

The transmission signal can be expressed according to the data flow illustrated in FIG. 20, as equation 31 below:

$${{S}^{n} ( t )}^{′} = \frac{A}{\sqrt{2}} \vert cos {θ}_{k} \vert cos ( {ω}_{c} t + {φ}_{l}^{′} ) - \frac{A}{\sqrt{2}} \vert sin {θ}_{k} \vert sin ( {ω}_{c} t + {φ}_{Q}^{′} ) \qquad ( 31 )$$

By using the characteristics of a trigonometric function, equation 31 can be expressed as equation 32 below:

$${{S}^{n} ( t )}^{′} = \frac{A}{\sqrt{2}} \vert cos {θ}_{k} \vert cos ( {ω}_{c} t + {φ}_{l}^{′} ) + \frac{A}{\sqrt{2}} \vert sin {θ}_{k} \vert cos ( {ω}_{c} t + π / 2 + {φ}_{Q}^{′} ) \qquad ( 32 )$$

When equation 32 and equation 30 are compared with respect to each term, relationships of φ_{I}′=θₖ, and φ_{Q}′=θₖ−π/2 are derived.

Second, a case where θₖ is positioned in the second quadrant will be explained. Here, since cosθₖ=−|cosθₖ|, and sinθₖ=|sinθₖ|, equation 28 can be expressed as equation 33 below:

S_{MPSK}^{( )}(t)=−A|cos θₖ|cos ω_{c}t+A|sin θₖ|cos(ω_{c}t+π/2)=A cos(ω_{c}t+θₖ) (33)

By using the characteristics of a trigonometric function, equation 33 can be expressed as equation 34 below:

S_{MPSK}^{( )}(t)=A|cos θₖ|cos ω_{c}t+π)+A|sin θₖ|cos(ω_{c}t+π/2)=A cos(ω_{c}t+θₖ) (34)

When the principle of the present invention is applied as in the first quadrant's case described above, the transmission signal according to the embodiment of FIG. 20 in the second quadrant is expressed as equation 35 below, which is the same as equation 30:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 35 )$$

When equation 35 is compared with equation 33, the modulation method of the present invention provides the effect of transmitting the phase θₖ of the existing message signal by using a carrier wave whose amplitude is increased by |cos θₖ|+|sin θₖ| compared to the conventional carrier wave.

The transmission signal can be expressed according to the data flow illustrated in FIG. 20, as equation 36 below:

$${{S}^{n} ( t )}^{′} = \frac{A}{\sqrt{2}} \vert cos {θ}_{k} \vert cos ( {ω}_{c} t + {φ}_{l}^{′} ) - \frac{A}{\sqrt{2}} \vert sin {θ}_{k} \vert sin ( {ω}_{c} t + {φ}_{Q}^{′} ) \qquad ( 36 )$$

By using the characteristics of a trigonometric function, equation 36 can be expressed as equation 37 below:

$${{S}^{n} ( t )}^{′} = \frac{A}{\sqrt{2}} \vert cos {θ}_{k} \vert cos ( {ω}_{c} t + π + {φ}_{l}^{′} ) + \frac{A}{\sqrt{2}} \vert sin {θ}_{k} \vert cos ( {ω}_{c} t + π / 2 + {φ}_{Q}^{′} ) \qquad ( 37 )$$

When equation 37 and equation 35 are compared with respect to each term, relationships of φᵢ′=θₖ+π and φ_{Q}′=θₖ−π/2 are derived.

Third, a case where θₖ is positioned in the third quadrant will be explained. Here, since cosθₖ=−|cosθₖ|, and sin θₖ=−|sinθₖ, equation 28 can be expressed as equation 38 below:

S_{MPSK}^{( )}(t)=−A|cos θₖ|cos ω_{c}t−A|sin θₖ|cos(ω_{c}t+π/2)=A cos(ω_{c}t+θₖ) (38)

By using the characteristics of a trigonometric function, equation 38 can be expressed as equation 39 below:

S_{MPSK}^{( )}(t)=A|cos θₖ|cos(ω_{c}t+π)+A|sin θₖ|cos(ω_{c}t+3π/2)=A cos(ω_{c}t+θₖ) (39)

When the principle of the present invention is applied as in the first quadrant's case described above, the transmission signal according to the embodiment of FIG. 20 in the third quadrant is expressed as equation 40 below, which is the same as equation 30:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 40 )$$

When equation 40 is compared with equation 35, the modulation method of the present invention provides the effect of transmitting the phase θₖ of the existing message signal by using a carrier wave whose amplitude is increased by cosθₖ|+|sin θₖ| compared to the conventional carrier wave.

The transmission signal can be expressed according to the data flow illustrated in FIG. 20, as equation 41 below:

$${{S}^{n} ( t )}^{′} = - \frac{A}{\sqrt{2}} \vert cos {θ}_{k} \vert cos ( {ω}_{c} t + {φ}_{l}^{′} ) + \frac{A}{\sqrt{2}} \vert sin {θ}_{k} \vert sin ( {ω}_{c} t + {φ}_{Q}^{′} ) \qquad ( 41 )$$

By using the characteristics of a trigonometric function, equation 41 can be expressed as equation 42 below:

$${{S}^{n} ( t )}^{′} = \frac{A}{\sqrt{2}} \vert cos {θ}_{k} \vert cos ( {ω}_{c} t + π + {φ}_{l}^{′} ) + \frac{A}{\sqrt{2}} \vert sin {θ}_{k} \vert cos ( {ω}_{c} t + 3 π / 2 + {φ}_{Q}^{′} ) \qquad ( 42 )$$

When equation 42 and equation 41 are compared with respect to each term, relationships of φ_{I}′=θₖ−π and φ_{Q}′=θₖ−3π/2 are derived.

Fourth, a case where θₖ is positioned in the fourth quadrant will be explained. Here, since cosθₖ=|cosθₖ|, and sinθₖ=−|sinθₖ|, equation 28 can be expressed as equation 43 below:

S_{MPSK}^{( )}(t)=A|cos θₖ|cos ω_{c}t−A|sin φₖ|cos(ω_{c}t+π/2)=A cos(ω_{c}t+θₖ) (43)

By using the characteristics of a trigonometric function, equation 43 can be expressed as equation 44 below:

S_{MPSK}^{( )}(t)=A|cos θₖ|cos ω_{c}t+A|sin θₖ|cos(ω_{c}t+3π/2)=A cos(ω_{c}t+θₖ) (44)

When the principle of the present invention is applied as in the first quadrant's case described above, the transmission signal according to the embodiment of FIG. 20 in the fourth quadrant is expressed as equation 45 below, which is the same as equation 30:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 45 )$$

When equation 45 is compared with equation 44, the modulation method of the present invention provides the effect of transmitting the phase θₖ of the existing message signal by using a carrier wave whose amplitude is increased by |cos θₖ|+|sin θₖ| compared to the conventional carrier wave.

The transmission signal can be expressed according to the data flow illustrated in FIG. 20, as equation 46 below:

$${{S}^{n} ( t )}^{′} = \frac{A}{\sqrt{2}} \vert cos {θ}_{k} \vert cos ( {ω}_{c} t + {φ}_{l}^{′} ) + \frac{A}{\sqrt{2}} \vert sin {θ}_{k} \vert sin ( {ω}_{c} t + {φ}_{Q}^{′} ) \qquad ( 46 )$$

By using the characteristics of a trigonometric function, equation 46 can be expressed as equation 47 below:

$${{S}^{n} ( t )}^{′} = \frac{A}{\sqrt{2}} \vert cos {θ}_{k} \vert cos ( {ω}_{c} t + {φ}_{l}^{′} ) + \frac{A}{\sqrt{2}} \vert sin {θ}_{k} \vert cos ( {ω}_{c} t + 3 π / 2 + {φ}_{Q}^{′} ) \qquad ( 47 )$$

When equation 47 and equation 46 are compared with respect to each term, relationships of φ_{I}′φₖ and φ_{Q}′=θₖ−3π/2 are derived.

Table 5 illustrates angles φ′_{I} and φ′_{Q} corresponding to phase adjustment values of the phase shifters 880 and 890 illustrated in FIG. 20. As described above with reference to table 2, the values φ′_{I} and φ′_{Q} are based on the assumption that rotation angles are measured counterclockwise and are in the range of [0,2 π]. Here, φ_{I}=φ′_{I} and φ_{Q}=π/2+φ′_{Q}.

TABLE 5

| Classification | θ Range | φ_{I} | φ_{Q} |
|---|---|---|---|
| θ Quadrant I | 0 < θ ≦ π/2 | θ | θ − π/2 |
| θ Quadrant II | π/2 < θ ≦ π | θ + π | θ − π/2 |
| θ Quadrant III | π < θ ≦ 3π/2 | θ − π | θ − 3π/2 |
| θ Quadrant IV | 3π/2 < θ ≦ 2π | θ | θ − 3π/2 |

In the same manner, in relation to the transmission signal according to the embodiment of FIG. 19, a constructive interference phenomenon will now be explained in an intuitive method.

The transmission signal of FIG. 19 can be expressed as equation 48 below:

$$\begin{matrix}S ( t ) = A cos {θ}_{k} cos ( {ω}_{c} t + {φ}_{l} ) + A sin {θ}_{k} cos ( {ω}_{c} t + {φ}_{Q} ) \\ = A cos ( {ω}_{c} t + {θ}_{k} )\end{matrix} \qquad ( 48 )$$

In the present invention, the phase φ_{I} and phase φ_{Q} of the sine wave in equation 48 are made to be the same, such that the phase of the final transmission signal is θₖ. In this way, the amplitude of the signal is made to be greater than the amplitude A of that according to the conventional modulation method, while transmitting the original message information.

An amplitude increasing effect by adjusting the phases φ_{I} and φ_{Q} when θₖ is positioned in each quadrant will now be explained in a quantitative way.

First, a case where θₖ is positioned in the first quadrant will be explained. Here, since cosθₖ=|cosθₖ|, and sin θₖ=|sinθₖ|, the transmission signal Sⁿ(t) according to the embodiment of FIG. 19 is expressed as equation 49:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 49 )$$

When equation 49 is compared with equation 29 expressing the transmission signal according to the conventional method, the modulation method of the present invention provides the effect of transmitting the phase φₖ of the existing message signal by using a carrier wave whose amplitude is increased by |cos θₖ|+|sin θₖ|.

When the phases of sine waves are compared with respect to each term, relationships of φ_{I}=θₖ and φ_{Q}=θₖ are derived.

Second, a case where θₖ is positioned in the second quadrant will be explained. Here, since cosθₖ=−|cosθₖ|, and sinθₖ=|sinθₖ|, the transmission signal Sⁿ(t) according to the embodiment of FIG. 19 is expressed as equation 50:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 50 )$$

When equation 50 is compared with equation 34 expressing the transmission signal according to the conventional method, the modulation method of the present invention provides the effect of transmitting the phase θₖ of the existing message signal by using a carrier wave whose amplitude is increased by |cosθₖ |+|sin θₖ |. When the phases of sine waves are compared with respect to each term, relationships of φ_{I}=θₖ+π and φ_{Q}=θₖ are derived.

Third, a case where θₖ is positioned in the third quadrant will be explained. Here, since cosθₖ=−|cosθₖ|, and sinθₖ=−|sinθₖ|, the transmission signal Sⁿ(t) according to the embodiment of FIG. 19 is expressed as equation 51:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 51 )$$

When equation 51 is compared with equation 39 expressing the transmission signal according to the conventional method, the modulation method of the present invention provides the effect of transmitting the phase θₖ of the existing message signal by using a carrier wave whose amplitude is increased by |cosθₖ|+|sin θₖ|.

When the phases of sine waves are compared with respect to each term, relationships of φ_{I}=θₖ−π and φ_{Q}=θₖ−π are derived.

Fourth, a case where θₖ is positioned in the fourth quadrant will be explained. Here, since cosθₖ=|cosθₖ|, and sinθₖ=−|sinθₖ|, the transmission signal Sⁿ(t) according to the embodiment of FIG. 19 is expressed as equation 52:

$$\begin{matrix}{{S}^{n} ( t )}^{′} = A \vert cos {θ}_{k} \vert cos ( {ω}_{c} t + {θ}_{k} ) + A \vert sin {θ}_{k} \vert cos ( {ω}_{c} t + {θ}_{k} ) \\ = A ( \vert cos {θ}_{k} \vert + \vert sin {θ}_{k} \vert ) cos ( {ω}_{c} t + {θ}_{k} )\end{matrix} \qquad ( 52 )$$

When equation 52 is compared with equation 44 expressing the transmission signal according to the conventional method, the modulation method of the present invention provides the effect of transmitting the phase θₖ of the existing message signal by using a carrier wave whose amplitude is increased by |cosθₖ |+|sin φₖ|. When the phases of sine waves are compared with respect to each term, relationships of φ_{I}=θₖ and φ_{Q}=φₖ−π are derived.

So far, by modifying equations related to the transmission signals of FIGS. 19 and 20, it has been explained that the amplitude |Sⁿ_{MPSK}(t)| is |sinθₖ+|cosθₖ| times the amplitude |S^{o}_{MPSK}(t)|. The value of |sinθₖ|+|cosθₖ| is the same as \sqrt{1+|sin 2θ|} and a quantitative gain of a constructive interference effect occurring from the sum of two sine waves.

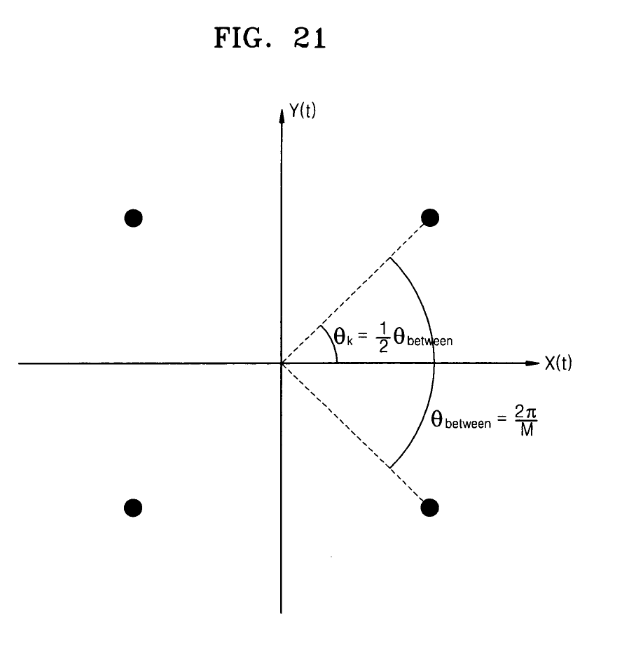

FIG. 21 is a diagram illustrating an angle that is the base of an amplitude gain according to an embodiment of the present invention.

Referring to FIG. 21, θₖ is

$${θ}_{k} = \frac{1}{2} {θ}_{between}$$

in the first quadrant in a signal constellation diagram which assumes symmetry about an axis, as described above. That is, the angle between two neighboring signals relates to an amplitude gain. The smaller the angle between the signals, the narrower the space in the signal constellation diagram becomes. Accordingly, it can be predicted that the amplitude gain by constructive interference is reduced if the angle is small. The quantitative gain can be expressed as equation 53 below:

\sqrt{1+|sin 2θₖ|}=\sqrt{1+|sin θ_{between}|} (53)

The amplitude gain of equation 53 matches an amplitude gain derived from a process which will now be explained. A symbol phase θₖ is one of the symbol phases θₖ=(2i−1)π/M (i=1, 2, . . . , M), and the amplitude gains in all quadrants are identical. Accordingly, if only the case where i=1 is considered, the amplitude |S^{o}_{MPSK}(t)| of an MPSK signal generated according to the present invention is expressed as equation 54 below:

$$\begin{matrix}\vert {S}_{MPSK}^{n} ( t ) \vert = \sqrt{1 + \vert sin 2 {θ}_{k} \vert} A \\ = \sqrt{1 + \vert sin \frac{2 ( 2 i - 1 ) π}{M} \vert} A \\ = \sqrt{1 + \vert sin \frac{2 π}{M} \vert A}\end{matrix} \qquad ( 54 )$$

Referring to equation 54, the amplitude increasing effect of the MPSK signal according to the present invention relies on an M-ary value. In the case of BPSK when M=2, there is no effect. In the case of QPSK when M=4, the effect is \sqrt{2} times, which is a maximum. If M is greater than 4, the amplitude increase of the MPSK signal according to the present invention is less than \sqrt{2}.

Overall, in the case of MPSK, the final transmission signal according to the present invention is expressed as equation 55 below:

$$\begin{matrix}{S}^{n} ( t ) = A ( cos {θ}_{i} + sin {θ}_{i} ) cos ( {ω}_{c} t + {θ}_{i} ) \\ = A ( cos 2 π / M + sin 2 π / M ) cos ( {ω}_{c} t + {θ}_{i} )\end{matrix} \qquad ( 55 )$$

Here, since θᵢ is also expressed as equation 5, phase information corresponding to information to be transmitted is transferred to the transmission signal whose amplitude is increased, in the same manner, and the transmission signal is demodulated by a conventional demodulation method.

So far, the principle of increasing amplitude by constructive interference of the present invention has been explained.

As a more specific example of M-PSK to which the present invention is applied, phase values φ_{I} and φ_{Q} with respect to QPSK when M=4, and the resulting amplitude gains, will now be explained in more detail.

A set of phases θₖ that a QPSK signal transmitted for the k-th time can have is {π/4, 3π/4, 5π/4, 7π/4}. By applying the phase θₖ to equations 25 and 26 for substitution, (Iₖ,Qₖ) are calculated with respect to each θₖ, and then, if table 2 is used, φ_{I} and φ_{Q} values with respect to the position of the phase θₖ in a quadrant can be obtained as illustrated in table 6. Table 6 assumes that φ_{I} and φ_{Q} values are in the range of [0,2π].

TABLE 6

| θₖ | (Iₖ, Qₖ) | φ_{I} | φ_{Q} |
|---|---|---|---|
| π/4 | (+1, +1) | π/4 | π/4 |
| 3π/4 | (−1, +1) | 7π/4 | 3π/4 |
| 5π/4 | (−1, −1) | π/4 | π/4 |
| 7π/4 | (+1, −1) | 7π/4 | 3π/4 |

According to the results of table 6, changes of φ_{I} and φ_{Q} values with respect to a QPSK signal are illustrated in table 7:

TABLE 7

| φ_{I} | φ_{Q} | \|φ_{Q} − φ_{I}\| |
|---|---|---|
| π/4 | π/4 | 0 |
| 7π/4 | 3π/4 | π |

In the conventional QPSK signal, the phases of a carrier wave are fixed to (φ_{I}, φ_{Q})=(0,π/2), and according to the phase of input data, the phase of a transmission signal becomes one of 4 phases. Meanwhile, in the QPSK to which the present invention is applied, the number of changing phases φ_{I} of the I channel carrier wave is 2, and the number of changing phases φ_{Q} of the Q channel carrier wave is 2. Accordingly, the phase of the transmission signal changes to any one of the 4 phases. That is, the phases change to (φ_{I}, φ_{Q})=(π/4,π/4) and (φ_{I}, φ_{Q})=(7π/4,3π/4). If 4 is substituted for M in equation 54, the signal amplitude of QPSK according to the present invention becomes f times the amplitude of the conventional method.

The amplitude of a sine wave signal generated by an oscillator that is an active device is a voltage. If it is assumed that the load resistance is 1 Ohm, the square of the voltage is in proportion to power. Accordingly, \sqrt{2} times the amplitude means 2 times the power.

As this power increasing effect, only when the two signals Iₖ and Qₖ of the I channel and the Q channel are 1 each, if the power of a transmission signal output from an I/Q modulator is fixed, the power consumption of a transmission oscillator according to the method of the present invention is reduced to half of the power consumption of the conventional method.

In QPKS modulation, another set of phases θₖ that a QPSK signal transmitted for the k-th time can have is {0, π/2, π, 3π/2}. In this case, as described above, the effect of constructive interference cannot be obtained. Accordingly, table 2 or table 6 suggested in the present invention cannot be used directly.

However, in table 3 the phase of each symbol is set by adding p, as illustrated in FIGS. 9A through 9C, and if π/4 is substituted for \sqrt{2} and the present invention is applied, the amplitude increasing effect of QPSK, off times, occurs as described above.

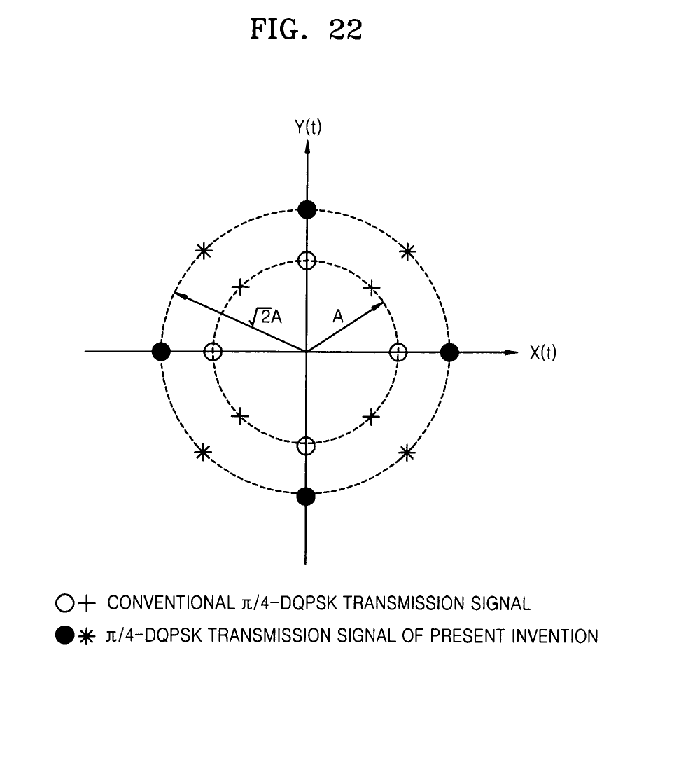

FIG. 22 is a signal constellation diagram of π/4-DQPSK according to an embodiment of the present invention.

Symbols + and indicate 4 signals that can be transmitted for the k-th time, and symbols ∘ and • indicate 4 signals that can be transmitted for the (k+1)-th time. The signal constellation diagram of the π/4-DQPSK is obtained by rotating the signal constellation diagram of the conventional QPSK modulation by 45 degrees at each symbol time interval Tₛ. If using tables 2 and 3, suggesting φ_{I} and φ_{Q} values with respect to the phase rotation of a signal according to the present invention, the constellation diagram of the π/4-DQPSK to which the present invention is applied becomes the pattern of •. The conventional π/4-DQPSK modulation method determines a transmission symbol by alternately using the constellation diagram marked with + and the constellation diagram marked with ∘, while the π/4-DQPSK modulation method according to the embodiment of the present invention determines a transmission symbol by alternately using the constellation diagram marked with and the constellation diagram marked with •, even with the same power consumption as the conventional method. That is, the modulation method according to the present invention increases the amplitude of the QPSK transmission signal to \sqrt{2} times the amplitude of the transmission signal of the conventional QPSK modulator, and thus the amplitude increasing effect of the transmission signal of the π/4-DQPSK modulation to which the present invention is applied is also \sqrt{2} times.

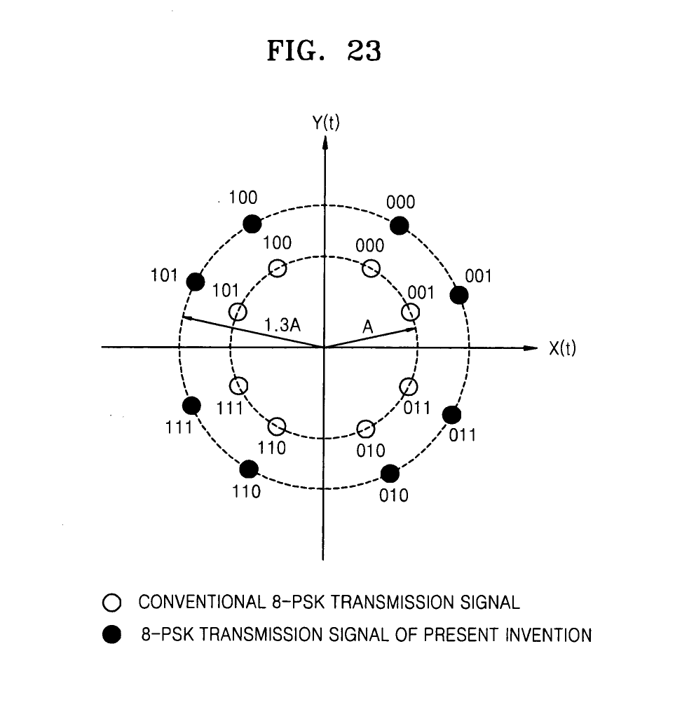

FIG. 23 is a signal constellation diagram of 8-PSK, illustrating a transmission signal generated by a conventional I/Q modulator and a transmission signal generated by an I/Q modulator according to an embodiment of the present invention, under the same power consumption conditions.

Referring to FIG. 23, it can be known that the amplitude of the transmission signal generated by the I/Q modulator according to the embodiment of the present invention is \sqrt{1+sin(π/4)} times greater than that generated by the conventional I/Q modulator.

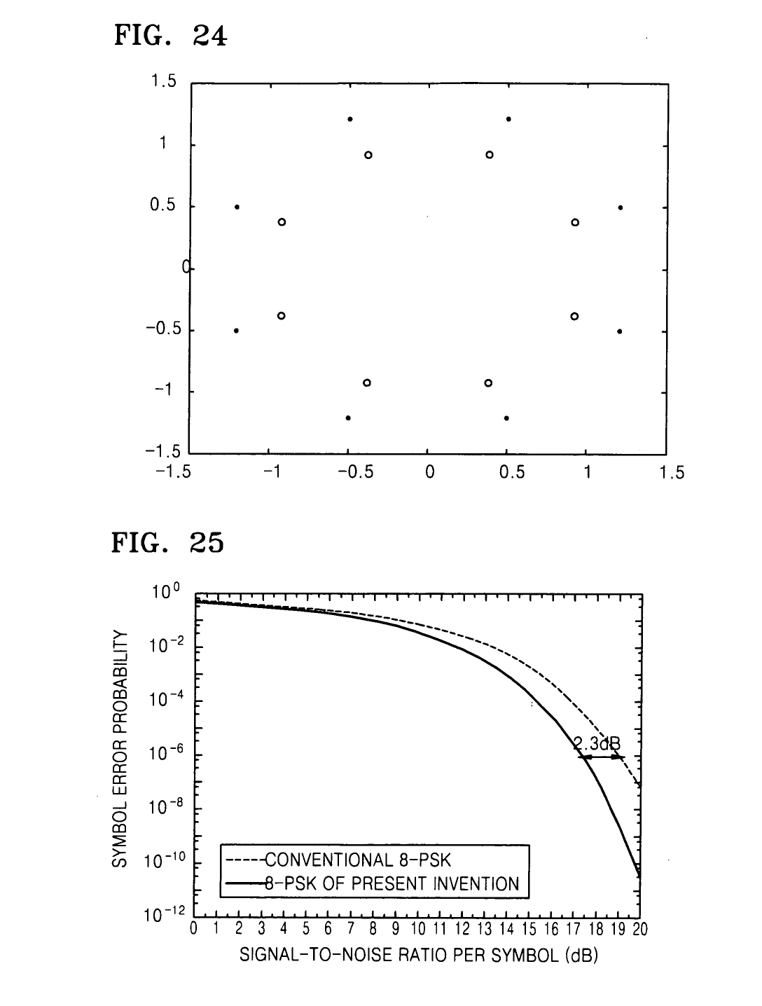

FIG. 24 is a constellation diagram of an actual transmission signal when A=1, corresponding to the diagram illustrated in FIG. 23. In FIG. 24, the transmission signal generated by the conventional 8-PSK I/Q modulator is expressed by symbol o, and the transmission signal generated by the I/Q modulator according to the embodiment of the present invention is expressed by symbol •.

The relationship between the amplitude A of a transmission signal and the symbol energy Eₛ is expressed as equation 56 below:

$$A = \sqrt{\frac{2 {E}_{S}}{{T}_{S}}} \qquad ( 56 )$$

Here, since the increased amplitude of the transmission signal of the 8-PSK to which the present invention is applied is 1.3 times the amplitude of the transmission signal of the conventional 8-PSK, the symbol energy increasing effect is 1.3²=1.7 times.

FIG. 25 is a diagram comparing the symbol error probability performance of the conventional 8-PSK modulation and the symbol error probability performance of the 8-PSK modulation according to the present invention, under an additive Gaussian white noise environment. The signal-to-noise ratio (SNR) per symbol required for the 8-PSK to which the present invention is applied, in order to achieve a symbol error probability performance of 10⁻⁶, is 2.3 dB (=10 log₁₀1.7) less than that of the conventional 8-PSK.

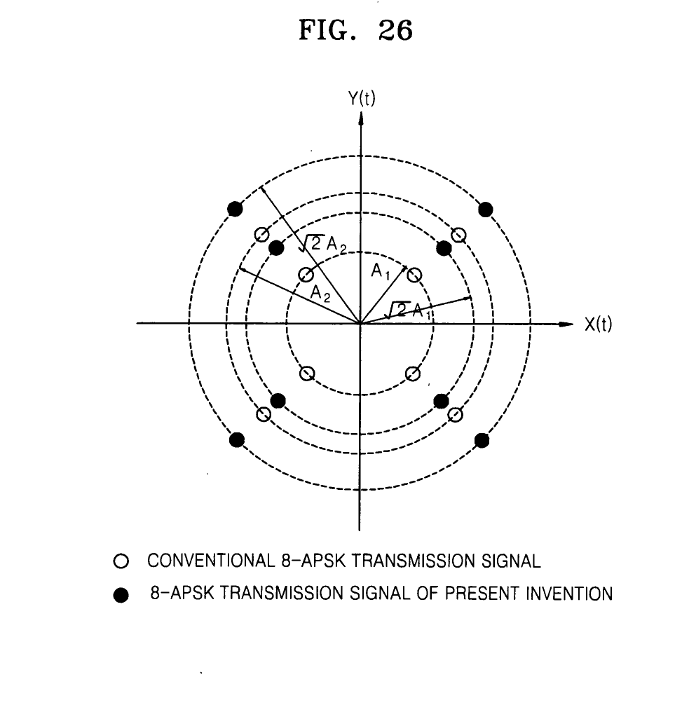

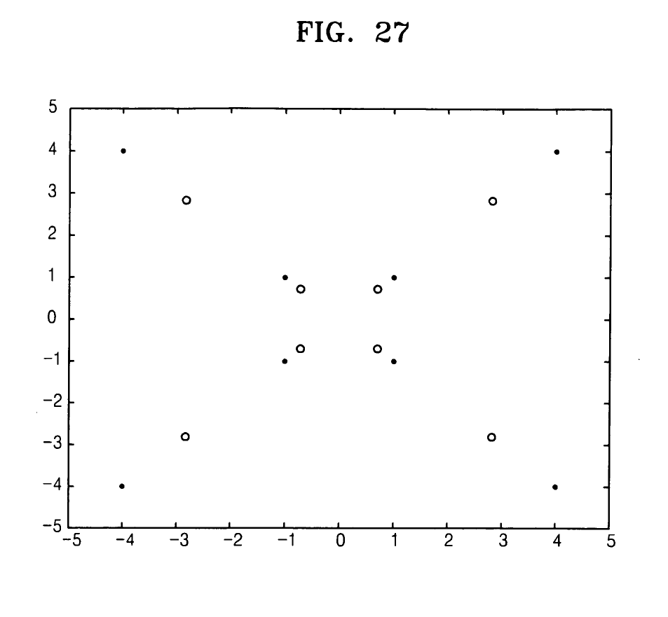

FIG. 26 is a constellation diagram of an 8-APSK signal generated by two QPSK modulators according to an embodiment of the present invention. The amplitude increasing effect of a transmission signal of the 8-APSK according to the present invention is \sqrt{2} times, as in the QPSK modulation.

FIG. 27 is the signal constellation diagram illustrated in FIG. 26 expressed in relation to the case where A₁=1 and A₂=4A₁. In FIG. 27, the transmission signal generated by the conventional 8-APSK I/Q modulator is expressed by symbol o, and the transmission signal generated by the I/Q modulator according to the embodiment of the present invention is expressed by symbol •.

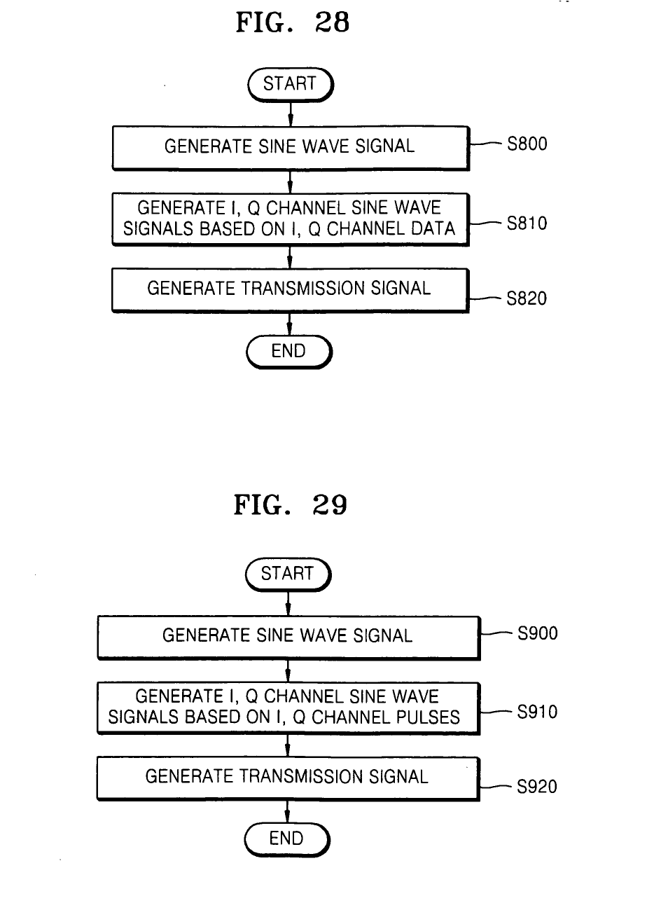

FIG. 28 is a flowchart illustrating an I/Q modulation method according to an embodiment of the present invention. Referring to FIG. 10, the flowchart of FIG. 28 will now be explained.

In operation S800, the oscillator 720 generates the sine wave signal (S4).

In operation S810, the IQ sine wave signal generation unit 740 adjusts the phase of the sine wave signal (S4) based on the I and Q channel data (S2, S3), and generates the I channel sine wave signal (S5) and the Q channel sine wave signal (S6) satisfying the condition that the signal obtained by combining the first signal, obtained by applying the I channel data (S2) to the I channel sine wave signal (S5), and the second signal, obtained by applying the Q channel data (S3) to the Q channel sine wave signal (S6), has a phase on the signal constellation diagram corresponding to the I and Q channel data (S2, S3).

In operation S820, the transmission signal generation unit 760 respectively applies the I channel data (S2) and the Q channel data (S3) to the I channel sine wave signal (S5) and the Q channel sine wave signal (S6), thereby generating the transmission signal (S7) corresponding to the I and Q channel data (S2, S3).

Since the detailed processing of the signals is the same as that explained above with reference to the I/Q modulation apparatus of FIG. 10, the explanation will not be repeated here.

FIG. 29 is a flowchart illustrating an I/Q modulation method according to another embodiment of the present invention.

Referring to FIG. 11, the flowchart of FIG. 29 will now be explained.

In operation S900, the oscillator 820 generates the sine wave signal (S14).

In operation S901, the IQ sine wave signal generation unit 840 adjusts the phase of the sine wave signal (S14) based on the I and Q channel pulses (S12, S13), and generates the I channel sine wave signal (S15) and the Q channel sine wave signal (S16) satisfying the condition that the signal obtained by combining the first signal, obtained by applying the I channel pulse (S12) to the I channel sine wave signal (S15), and the second signal, obtained by applying the Q channel pulse (S13) to the Q channel sine wave signal (S16), has a phase in the signal constellation diagram corresponding to the I and Q channel pulses (S12, S13).

In operation S920, the transmission signal generation unit 860 respectively applies the I channel pulse (S12) and the Q channel pulse (S13) to the I channel sine wave signal (S15) and the Q channel sine wave signal (S16), thereby generating the transmission signal (S17) corresponding to the I and Q channel pulses (S12, S13).

Since the detailed processing of the signals is the same as that explained above with reference to the I/Q modulation apparatus of FIG. 11, the explanation will not be repeated here.

The present invention can also be applied to QPSK, OQPSK, π/4-DQPSK, Walsh QPSK, hybrid QPSK, MPSK, APSK, and hierarchical PSK. However, it can be easily understood by a person skilled in the art that the present invention is not limited to these, and can be applied to all modulation systems which generate a transmission signal by using an I channel sine wave and a Q channel sine wave.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

According to the present invention, the symbol error probability performance of a conventional I/Q modulation method can be improved by a maximum of 3 dB under the same power consumption conditions. In other words, the power consumption required to obtain the same SER performance can be lower than that of the conventional I/Q modulator. Also, demodulation of a transmission signal modulated by an I/Q modulator of the present invention can be performed directly by a conventional I/Q demodulator, because compatibility with conventional systems is provided by the present invention.

While the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An I/Q modulation apparatus comprising:
an oscillator generating a sine wave signal;
an IQ sine wave signal generation unit adjusting the phase of the sine wave signal based on I channel data and Q channel data, thereby generating an I channel sine wave signal and a Q channel sine wave signal such that a signal obtained by mixing a first signal and a second signal satisfies the condition that the mixed signal has a phase on a signal constellation diagram corresponding to the I and Q channel data, in which the first signal is obtained by applying the I channel data to the I channel sine wave signal and the second signal obtained by applying the Q channel data to the Q channel sine wave signal; and
a transmission signal generation unit generating a transmission signal corresponding to the I and Q channel data, by respectively applying the I channel data and the Q channel data to the I channel sine wave signal and the Q channel sine wave signal.

2. The apparatus of claim 1, wherein the IQ sine wave signal generation unit generates the I channel sine wave signal and the Q channel sine wave signal that satisfy the condition that the absolute value of the phase difference between the first signal and the second signal is 2 nπ (here, n is an integer equal to or greater than 0).

3. The apparatus of claim 1, wherein the IQ sine wave signal generation unit generates the I channel sine wave signal and the Q channel sine wave signal that satisfy the condition that the absolute value of the phase difference between the first signal and the second signal belongs to (2 nπ, 2 nπ+Pπ/2) (here, n is an integer equal to or greater than 0).

4. The apparatus of claim 1, further comprising an I/Q data generation unit generating the I channel data and the Q channel data by converting a binary stream according to an I/Q modulation technique.

5. The apparatus of claim 1, wherein the transmission signal generation unit comprises:
an I channel mixer applying the I channel data to the I channel sine wave signal;
a Q channel mixer applying the Q channel data to the Q channel sine wave signal; and
a combining unit combining the output of the I channel mixer and the output of the Q channel mixer.

6. The apparatus of claim 5, wherein the transmission signal generation unit further comprises:
an I channel filter converting the I channel data to a predetermined pulse; and
a Q channel filter converting the Q channel data to a predetermined pulse,
wherein the I channel mixer mixes the output of the I channel filter and the I channel sine wave signal, and provides the result to the combining unit, and the Q channel mixer mixes the output of the Q channel filter and the Q channel sine wave signal, and provides the result to the combining unit.

7. The apparatus of claim 1, wherein the IQ sine wave signal generation unit comprises:
an I channel phase shift unit shifting the phase of the sine wave signal, thereby generating the I channel sine wave signal;
a Q channel phase shift unit shifting the phase of the sine wave signal, thereby generating the Q channel sine wave signal; and
a phase adjustment unit adjusting the phase shifts of the I channel phase shift unit and the Q channel phase shift unit based on the I and Q channel data.

8. The apparatus of claim 7, wherein the phase adjustment unit comprises:
a phase detection unit detecting the phases in a signal constellation diagram corresponding to the I and Q channel data; and
a phase control unit adjusting the phase shifts of the I channel phase shift unit and the Q channel phase shift unit based on the detected phases.

9. The apparatus of claim θ, wherein the phase detection unit detects the phases by using the equation below:
$${tan}^{- 1 *} ( \frac{Q}{I} ) {=}^{Δ} \frac{π}{2} [ 1 - sgn ( I ) ] + sgn ( I ) {tan}^{- 1} ( \frac{Q}{\vert I \vert} ) + \frac{π}{2} [ 1 - sgn ( I ) sgn ( IQ ) ] [ 1 + sgn ( I ) sgn ( IQ ) ]$$
where I is the I channel data, Q is the Q channel data, and the left-hand side of the equation is the detected phase.

10. The apparatus of claim 10, wherein the I/Q modulation technique includes offset quadrature phase shifting keying (OQPSK), π/4-differential quadrature phase shifting keying (DQPSK), Walsh QPSK, hybrid QPSK, M-ary phase shift keying (M-PSK) (M>4), amplitude phase shift keying (APSK), hierarchical PSK, and M-QAM.

11. The apparatus of claim 2, wherein the IQ sine wave signal generation unit comprises:
a phase detection unit detecting the phases in the signal constellation diagram corresponding to the I and Q channel data;
an I channel sine wave signal generation unit, if the I channel data is equal to or less than 0, shifting the phase of the sine wave signal such that the phase of the I channel sine wave signal becomes a phase obtained by adding 2mπ+π (here, m is an integer) to the detected phase, and if the I channel data is greater than 0, shifting the phase of the sine wave signal such that the phase of the I channel sine wave signal becomes the detected phase, and thereby generating the I channel sine wave signal; and
a Q channel sine wave signal generation unit, if the Q channel data is equal to or less than 0, shifting the phase of the sine wave signal such that the phase of the Q channel sine wave signal becomes a phase obtained by adding 2mπ+π (here, m is an integer) to the detected phase, and if the Q channel data is greater than 0, shifting the phase of the sine wave signal such that the phase of the Q channel sine wave signal becomes the detected phase, and thereby generating the Q channel sine wave signal.

12. The apparatus of claim 2, wherein the IQ sine wave signal generation unit comprises:
a phase detection unit detecting the phases in the signal constellation diagram corresponding to the I and Q channel data;
an I channel sine wave signal generation unit, if the I channel data is equal to or less than 0, shifting the phase of the sine wave signal such that the phase of the I channel sine wave signal becomes a phase obtained by adding 2 mπ+π (here, m is an integer) to the detected phase, and if the I channel data is greater than 0, shifting the phase of the sine wave signal such that the phase of the I channel sine wave signal becomes the detected phase, and thereby generating the I channel sine wave signal; and
a Q channel sine wave signal generation unit, if the Q channel data is less than 0, shifting the phase of the sine wave signal such that the phase of the Q channel sine wave signal becomes a phase obtained by adding 2 mπ+π(here, m is an integer) to the detected phase, and if the Q channel data is equal to or greater than 0, shifting the phase of the sine wave signal such that the phase of the Q channel sine wave signal becomes the detected phase, and thereby generating the Q channel sine wave signal.

13. The apparatus of claim 2, wherein the IQ sine wave signal generation unit comprises:
a phase detection unit detecting the phases in the signal constellation diagram corresponding to the I and Q channel data;
an I channel sine wave signal generation unit, if the I channel data is less than 0, shifting the phase of the sine wave signal such that the phase of the I channel sine wave signal becomes a phase obtained by adding 2 mπ+π (here, m is an integer) to the detected phase, and if the I channel data is equal to or greater than 0, shifting the phase of the sine wave signal such that the phase of the I channel sine wave signal becomes the detected phase, and thereby generating the I channel sine wave signal; and
a Q channel sine wave signal generation unit, if the Q channel data is equal to or less than 0, shifting the phase of the sine wave signal such that the phase of the Q channel sine wave signal becomes a phase obtained by adding 2 mπ+π (here, m is an integer) to the detected phase, and if the Q channel data is greater than 0, shifting the phase of the sine wave signal such that the phase of the Q channel sine wave signal becomes the detected phase, and thereby generating the Q channel sine wave signal.

14. The apparatus of claim 2, wherein the IQ sine wave signal generation unit comprises:
a phase detection unit detecting the phases in the signal constellation diagram corresponding to the I and Q channel data;
an I channel sine wave signal generation unit, if the I channel data is less than 0, shifting the phase of the sine wave signal such that the phase of the I channel sine wave signal becomes a phase obtained by adding 2 mπ+π (here, m is an integer) to the detected phase, and if the I channel data is equal to or greater than 0, shifting the phase of the sine wave signal such that the phase of the I channel sine wave signal becomes the detected phase, and thereby generating the I channel sine wave signal; and
a Q channel sine wave signal generation unit, if the Q channel data is less than 0, shifting the phase of the sine wave signal such that the phase of the Q channel sine wave signal becomes a phase obtained by adding 2 mπ+π (here, m is an integer) to the detected phase, and if the Q channel data is equal to or greater than 0, shifting the phase of the sine wave signal such that the phase of the Q channel sine wave signal becomes the detected phase, and thereby generating the Q channel sine wave signal.

15. The apparatus of claim 2, wherein the IQ sine wave signal generation unit comprises:
an I channel phase shift unit shifting the phase of the sine wave signal, thereby generating the I channel sine wave signal;
a Q channel phase shift unit shifting the phase of the sine wave signal, thereby generating the Q channel sine wave signal; and
a phase adjustment unit adjusting the phase shifts of the I channel phase shift unit and the Q channel phase shift unit, based on the I and Q channel data.

16. The apparatus of claim 15, wherein the phase adjustment unit comprises:
a phase detection unit detecting the phases in the signal constellation diagram corresponding to the I and Q channel data; and
a phase control unit, if the I channel data is equal to or less than 0, determining the phase shift of the I channel phase shift unit according to a phase obtained by adding 2 mπ+π (here, m is an integer) to the detected phase, and if the I channel data is greater than 0, determining the phase shift of the I channel phase shift unit according to the detected phase, and if the Q channel data is equal to or less than 0, determining the phase shift of the Q channel phase shift unit according to a phase obtained by adding 2 nπ+π (here, n is an integer) to the detected phase, and if the Q channel data is greater than 0, determining the phase shift of the Q channel phase shift unit according to the detected phase, and then respectively adjusting the phase shift of the I channel phase shift unit and the phase shift of the Q channel phase shift unit according to the determined phase shifts.

17. The apparatus of claim 15, wherein the phase adjustment unit comprises:
a phase detection unit detecting the phases in the signal constellation diagram corresponding to the I and Q channel data; and
a phase control unit, if the I channel data is equal to or less than 0, determining the phase shift of the I channel phase shift unit according to a phase obtained by adding 2 mπ+π (here, m is an integer) to the detected phase, and if the I channel data is greater than 0, determining the phase shift of the I channel phase shift unit according to the detected phase, and if the Q channel data is less than 0, determining the phase shift of the Q channel phase shift unit according to a phase obtained by adding 2 nπ+π (here, n is an integer) to the detected phase, and if the Q channel data is equal to or greater than 0, determining the phase shift of the Q channel phase shift unit according to the detected phase, and then respectively adjusting the phase shift of the I channel phase shift unit and the phase shift of the Q channel phase shift unit according to the determined phase shifts.

18. The apparatus of claim 15, wherein the phase adjustment unit comprises:
a phase detection unit detecting the phases in the signal constellation diagram corresponding to the I and Q channel data; and
a phase control unit, if the I channel data is less than 0, determining the phase shift of the I channel phase shift unit according to a phase obtained by adding 2mπ+π (here, m is an integer) to the detected phase, and if the I channel data is equal to or greater than 0, determining the phase shift of the I channel phase shift unit according to the detected phase, and if the Q channel data is equal to or less than 0, determining the phase shift of the Q channel phase shift unit according to a phase obtained by adding 2 nπ+π (here, n is an integer) to the detected phase, and if the Q channel data is greater than 0, determining the phase shift of the Q channel phase shift unit according to the detected phase, and then respectively adjusting the phase shift of the I channel phase shift unit and the phase shift of the Q channel phase shift unit according to the determined phase shifts.

19. The apparatus of claim 15, wherein the phase adjustment unit comprises:
a phase detection unit detecting the phases in the signal constellation diagram corresponding to the I and Q channel data; and
a phase control unit, if the I channel data is less than 0, determining the phase shift of the I channel phase shift unit according to a phase obtained by adding 2mπ+π (here, m is an integer) to the detected phase, and if the I channel data is equal to or greater than 0, determining the phase shift of the I channel phase shift unit according to the detected phase, and if the Q channel data is less than 0, determining the phase shift of the Q channel phase shift unit according to a phase obtained by adding 2 nπ+π (here, n is an integer) to the detected phase, and if the Q channel data is equal to or greater than 0, determining the phase shift of the Q channel phase shift unit according to the detected phase, and then respectively adjusting the phase shift of the I channel phase shift unit and the phase shift of the Q channel phase shift unit according to the determined phase shifts.

20. An I/Q modulation apparatus comprising:
an oscillator generating a sine wave signal;
an I/Q channel pulse generation unit generating I and Q channel pulses;
an IQ sine wave signal generation unit adjusting the phase of the sine wave signal based on the I and Q channel pulses, thereby generating an I channel sine wave signal and a Q channel sine wave signal such that a signal obtained by mixing a first signal and a second signal satisfies the condition that the mixed signal has a phase on a signal constellation diagram corresponding to the I and Q channel pulses, in which the first signal is obtained by applying the I channel pulse to the I channel sine wave signal and the second signal obtained by applying the Q channel pulse to the Q channel sine wave signal; and
a transmission signal generation unit generating a transmission signal corresponding to the I and Q channel pulses, by respectively applying the I channel pulse and the Q channel pulse to the I channel sine wave signal and the Q channel sine wave signal.

21. The apparatus of claim 20, wherein the IQ sine wave signal generation unit generates the I channel sine wave signal and the Q channel sine wave signal that satisfy the condition that the absolute value of the phase difference between the first signal and the second signal is 2 nπ (here, n is an integer equal to or greater than 0).

22. The apparatus of claim 20, wherein the IQ sine wave signal generation unit generates the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0).

23. The apparatus of claim 20, wherein the I/Q channel pulse generation unit comprises:
an I/Q data generation unit converting a binary stream according to an I/Q modulation technique, thereby generating I channel data and Q channel data;
an I channel filter converting the I channel data to the I channel pulse; and
a Q channel filter converting the Q channel data to the Q channel pulse.

24. The apparatus of claim 20, wherein the transmission signal generation unit comprises:
an I channel mixer mixing the I channel pulse and the I channel sine wave signal;
a Q channel mixer mixing the Q channel pulse and the Q channel sine wave signal; and
a combining unit combining the output of the I channel mixer and the output of the Q channel mixer.

25. The apparatus of claim 20, wherein the IQ sine wave signal generation unit comprises:
an I channel phase shift unit shifting the phase of the sine wave signal, thereby generating the I channel sine wave signal;
a Q channel phase shift unit shifting the phase of the sine wave signal, thereby generating the Q channel sine wave signal; and
a phase adjustment unit adjusting the phase shifts of the I channel phase shift unit and the Q channel phase shift unit based on the I and Q channel pulses.

26. The apparatus of claim 25, wherein the phase adjustment unit comprises:
a phase detection unit detecting the phases in a signal constellation diagram corresponding to the I and Q channel pulses; and
a phase control unit adjusting the phase shifts of the I channel phase shift unit and the Q channel phase shift unit based on the detected phases.

27. The apparatus of claim 21, wherein the IQ sine wave signal generation unit comprises:
a phase detection unit detecting the phases in the signal constellation diagram corresponding to the I and Q channel pulses;
an I channel sine wave signal generation unit, if the peak value of the I channel pulse is equal to or less than 0, shifting the phase of the sine wave signal such that the phase of the I channel sine wave signal becomes a phase obtained by adding 2mπ+π (here, m is an integer) to the detected phase, and if the peak value of the I channel pulse is greater than 0, shifting the phase of the sine wave signal such that the phase of the I channel sine wave signal becomes the detected phase, and thereby generating the I channel sine wave signal; and
a Q channel sine wave signal generation unit, if the peak value of the Q channel pulse is equal to or less than 0, shifting the phase of the sine wave signal such that the phase of the Q channel sine wave signal becomes a phase obtained by adding 2 mπ+π (here, m is an integer) to the detected phase, and if the peak value of the Q channel pulse is greater than 0, shifting the phase of the sine wave signal such that the phase of the Q channel sine wave signal becomes the detected phase, and thereby generating the Q channel sine wave signal.

28. The apparatus of claim 21, wherein the IQ sine wave signal generation unit comprises:
a phase detection unit detecting the phases in the signal constellation diagram corresponding to the I and Q channel pulses;
an I channel sine wave signal generation unit, if the peak value of the I channel pulse is equal to or less than 0, shifting the phase of the sine wave signal such that the phase of the I channel sine wave signal becomes a phase obtained by adding 2 mπ+π (here, m is an integer) to the detected phase, and if the peak value of the I channel pulse is greater than 0, shifting the phase of the sine wave signal such that the phase of the I channel sine wave signal becomes the detected phase, and thereby generating the I channel sine wave signal; and
a Q channel sine wave signal generation unit, if the peak value of the Q channel pulse is less than 0, shifting the phase of the sine wave signal such that the phase of the Q channel sine wave signal becomes a phase obtained by adding 2 mπ+π (here, m is an integer) to the detected phase, and if the peak value of the Q channel pulse is equal to or greater than 0, shifting the phase of the sine wave signal such that the phase of the Q channel sine wave signal becomes the detected phase, and thereby generating the Q channel sine wave signal.

29. The apparatus of claim 21, wherein the IQ sine wave signal generation unit comprises:
a phase detection unit detecting the phases in the signal constellation diagram corresponding to the I and Q channel pulses;
an I channel sine wave signal generation unit, if the peak value of the I channel pulse is less than 0, shifting the phase of the sine wave signal such that the phase of the I channel sine wave signal becomes a phase obtained by adding 2 mπ+π (here, m is an integer) to the detected phase, and if the peak value of the I channel pulse is equal to or greater than 0, shifting the phase of the sine wave signal such that the phase of the I channel sine wave signal becomes the detected phase, and thereby generating the I channel sine wave signal; and
a Q channel sine wave signal generation unit, if the peak value of the Q channel pulse is equal to or less than 0, shifting the phase of the sine wave signal such that the phase of the Q channel sine wave signal becomes a phase obtained by adding 2 mπ+π (here, m is an integer) to the detected phase, and if the peak value of the Q channel pulse is greater than 0, shifting the phase of the sine wave signal such that the phase of the Q channel sine wave signal becomes the detected phase, and thereby generating the Q channel sine wave signal.

30. The apparatus of claim 21, wherein the IQ sine wave signal generation unit comprises:
a phase detection unit detecting the phases in the signal constellation diagram corresponding to the I and Q channel pulses;
an I channel sine wave signal generation unit, if the peak value of the I channel pulse is less than 0, shifting the phase of the sine wave signal such that the phase of the I channel sine wave signal becomes a phase obtained by adding 2 mπ+π (here, m is an integer) to the detected phase, and if the peak value of the I channel pulse is equal to or greater than 0, shifting the phase of the sine wave signal such that the phase of the I channel sine wave signal becomes the detected phase, and thereby generating the I channel sine wave signal; and
a Q channel sine wave signal generation unit, if the peak value of the Q channel pulse is less than 0, shifting the phase of the sine wave signal such that the phase of the Q channel sine wave signal becomes a phase obtained by adding 2 mπ+π (here, m is an integer) to the detected phase, and if the peak value of the Q channel pulse is equal to or greater than 0, shifting the phase of the sine wave signal such that the phase of the Q channel sine wave signal becomes the detected phase, and thereby generating the Q channel sine wave signal.

31. The apparatus of claim 23, wherein the I/Q modulation technique includes OPQSK, π/4-DQPSK, Walsh QPSK, hybrid QPSK, M-PSK (M>4), APSK, hierarchical PSK, and M-QAM.

32. An I/Q modulation method comprising:
generating a sine wave signal;
adjusting the phase of the sine wave signal based on I channel data and Q channel data, thereby generating an I channel sine wave signal and a Q channel sine wave signal such that a signal obtained by mixing a first signal and a second signal satisfies the condition that the mixed signal has a phase on a signal constellation diagram corresponding to the I and Q channel data, in which the first signal is obtained by applying the I channel data to the I channel sine wave signal and the second signal obtained by applying the Q channel data to the Q channel sine wave signal; and
generating a transmission signal corresponding to the I and Q channel data, by respectively applying the I channel data and the Q channel data to the I channel sine wave signal and the Q channel sine wave signal.

33. The method of claim 32, wherein in the generating of the I and Q sine wave signals, the I channel sine wave signal and the Q channel sine wave signal that satisfy the condition that the absolute value of the phase difference between the first signal and the second signal is 2 nπ (here, n is an integer equal to or greater than 0) are generated.

34. The method of claim 32, wherein in the generating of the I and Q sine wave signals, the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0) are generated.

35. The method of claim 32, further comprising generating the I channel data and the Q channel data by converting a binary stream according to an I/Q modulation technique.

36. The method of claim 35, wherein the I/Q modulation technique includes OPQSK, π/4-DQPSK, Walsh QPSK, hybrid QPSK, M-PSK (M>4), APSK, hierarchical PSK, and M-QAM.

37. An I/Q modulation method comprising:
generating a sine wave signal;
generating I and Q channel pulses;
adjusting the phase of the sine wave signal based on the I and Q channel pulses, thereby generating an I channel sine wave signal and a Q channel sine wave signal such that a signal obtained by mixing a first signal and a second signal satisfies the condition that the mixed signal has a phase on a signal constellation diagram corresponding to the I and Q channel pulses, in which the first signal is obtained by applying the I channel pulse to the I channel sine wave signal and the second signal obtained by applying the Q channel pulse to the Q channel sine wave signal; and
generating a transmission signal corresponding to the I and Q channel pulses, by respectively applying the I channel pulse and the Q channel pulse to the I channel sine wave signal and the Q channel sine wave signal.

38. The method of claim 37, wherein in the generating of the I and Q sine wave signals, the I channel sine wave signal and the Q channel sine wave signal that satisfy the condition that the absolute value of the phase difference between the first signal and the second signal is 2 nπ (here, n is an integer equal to or greater than 0) are generated.

39. The method of claim 37, wherein in the generating of the I and Q sine wave signals, the I channel sine wave signal and the Q channel sine wave signal that satisfy the condition that the absolute value of the phase difference between the first signal and the second signal belongs to (2 nπ, 2 nπ+π/2) (here, n is an integer equal to or greater than 0) are generated.

40. The method of claim 37, wherein the generating of the I and Q channel pulses comprises:
converting a binary stream according to an I/Q modulation technique, thereby generating the I channel data and the Q channel data;
converting the I channel data to the I channel pulse; and
converting the Q channel data to the Q channel pulse.

41. The method of claim 40, wherein the I/Q modulation technique includes OPQSK, π/4-DQPSK, Walsh QPSK, hybrid QPSK, M-PSK (M>4), APSK, hierarchical PSK, and M-QAM.

42. A computer readable recording medium having embodied thereon a computer program for executing the method of any one of claims 32 through 41.
